(19) United States
(12) Patent Application Publication
(10) Pub. No.: US 2007/0253426 A1
(43) Pub. Date: Nov. 1, 2007

(54) Reliable global broadcasting in a multistage network

(75) Inventors: Jay R. Herring, Hyde Park, NY (US); Aruna V. Ramanan, Poughkeepsie, NY (US); Craig B. Stunkel, Bethel, CT (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/413,526

(22) Filed: Apr. 28, 2006

(51) Int. Cl. H04L 12/56

(52) U.S. Cl. 370/395.7

(57) ABSTRACT

Efficient, reliable broadcast support is provided to clients of a network built using switching elements that have the capability to replicate packets. Replication patterns are generated and used in broadcasting data in the network. The replication patterns are provided in hardware of the network to enable broadcasting from one node in the network to each node of a broadcast domain of the network.

### TECHNICAL FIELD

This invention relates, in general, to communications networks, and in particular, to reliable global broadcasting in a multistage communications network.

### BACKGROUND OF THE INVENTION

One type of communications network is a switch network. Examples of switch networks are described in U.S. Pat. No. 6,021,442, entitled “Method And Apparatus For Partitioning An Interconnection Medium In A Partitioned Multiprocessor Computer System,” Ramanan et al., issued Feb. 1, 2000; U.S. Pat. No. 5,884,090, entitled “Method And Apparatus For Partitioning An Interconnection Medium In A Partitioned Multiprocessor Computer System,” Ramanan et al., issued Mar. 16, 1999; U.S. Pat. No. 5,812,549, entitled “Route Restrictions For Deadlock Free Routing With Increased Bandwidth In A Multi-Stage Cross Point Packet Switch,” Sethu, issued Sep. 22, 1998; U.S. Pat. No. 5,453,978, entitled “Technique For Accomplishing Deadlock Free Routing Through A Multi-Stage Cross-Point Packet Switch,” Sethu et al., issued Sep. 26, 1995; and U.S. Pat. No. 5,355,364, entitled “Method Of Routing Electronic Messages,” Abali, issued Oct. 11, 1994, each of which is hereby incorporated herein by reference in its entirety.

A switch network offered by International Business Machines Corporation is the High Performance Switch (HPS) network. The High Performance Switch network provides hardware support for multicast. For example, the switching elements or switch chips have the capability to replicate incoming packets and to send the replicated packets out through multiple ports. This replication capability is described in U.S. Pat. No. 6,542,502, entitled “Multicasting Using A Worm Hole Routing Switching Element,” issued on Apr. 1, 2003, which is hereby incorporated herein by reference in its entirety. With this capability, replication is achieved using a central buffer. In particular, replication occurs during the read of the chunk out of the central buffer by the output ports.

### SUMMARY OF THE INVENTION

Although replication and multicasting are available, a need still exists for a capability to efficiently and reliably support global broadcast in a network. In particular, a need exists for a facility that exploits hardware replication in order to provide a broadcast function that performs at the speed of hardware.

The shortcomings of the prior art are overcome and additional advantages are provided through the provision of a method of facilitating broadcasting in a communications network. The method includes, for instance, generating one or more replication patterns to be used in broadcasting data in the communications network; and providing at least one replication pattern of the one or more replication patterns in hardware of the communications network to enable broadcasting from one node of the communications network to each node of a broadcast domain of the communications network.

In another aspect, a method of facilitating broadcasting in a multistage network is provided. The method includes, for instance, processing a plurality of switch chips of the multistage network starting with one or more switch chips closest to one or more hosts of the multistage network to one or more switch chips at a center stage of the multistage network to determine an ability of the plurality of switch chips to send data to one or more root chips at the center stage of the multistage network and to broadcast down to one or more hosts; processing back from the center stage one or more switch chips down to one or more switch chips at each host of a broadcast domain to further determine the ability of the plurality of switch chips to send data; and generating one or more replication patterns for one or more switch chips based on the processing of the plurality of switch chips and the processing back.

System and computer program products corresponding to one or more of the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one example of a switch network coupled to a service network, in accordance with an aspect of the present invention;

FIG. 2 depicts one embodiment of a switch board with 8 switch chips which can be employed in a communications network, in accordance with an aspect of the present invention;

FIG. 3 depicts one logical layout of switch boards in a 128-node system employing one or more aspects of the present invention;

FIG. 4 depicts one embodiment of a 256 endpoint switch block employing one or more aspects of the present invention;

FIG. 5 depicts a schematic of one embodiment of a 2048 endpoint communications network employing the 256 endpoint switch block of FIG. 4, in accordance with an aspect of the present invention;

FIG. 6 depicts one embodiment of the logic associated with setting a multicast pattern on switch chips in order to provide reliable, global broadcast in a multistage environment, in accordance with an aspect of the present invention;

FIG. 7 depicts one embodiment of the logic associated with the sweep up process of FIG. 6, in accordance with an aspect of the present invention;

FIG. 8 depicts one embodiment of the logic associated with processing level 1 chips during the sweep up process, in accordance with an aspect of the present invention;

FIG. 9 depicts further details regarding the processing of level 1 chips, in accordance with an aspect of the present invention;

FIG. 10 depicts one embodiment of the logic associated with processing next level chips during the sweep up process, in accordance with an aspect of the present invention;

FIGS. 11A-11B depict one embodiment of the logic associated with processing odd non-root chips during the sweep up process, in accordance with an aspect of the present invention;

FIGS. 12A-12B depict one embodiment of the logic associated with processing odd root chips during the sweep up process, in accordance with an aspect of the present invention;

FIG. 13 depicts one embodiment of the logic associated with processing even root chips during the sweep up process, in accordance with an aspect of the present invention;

FIGS. 14A-14B depict one embodiment of the logic associated with processing even non-root chips during the sweep up process, in accordance with an aspect of the present invention;

FIGS. 15A-15B depict one embodiment of the logic associated with processing chips at the same level on all boards during the sweep up process, in accordance with an aspect of the present invention;

FIG. 16 depicts one embodiment of the logic associated with the sweep down process of FIG. 6, in accordance with an aspect of the present invention;

FIG. 17 depicts one embodiment of the logic associated with processing boards with next level chips during the sweep down process, in accordance with an aspect of the present invention;

FIG. 18 depicts one embodiment of the logic associated with processing next level chips during the sweep down process, in accordance with an aspect of the present invention;

FIG. 19 depicts one embodiment of the logic associated with processing odd non-root chips during the sweep down process, in accordance with an aspect of the present invention;

FIG. 20 depicts one embodiment of the logic associated with processing even non-root chips during the sweep down process, in accordance with an aspect of the present invention;

FIG. 21 depicts one embodiment of the logic associated with processing chips at the same level on the same board during the sweep down process, in accordance with an aspect of the present invention;

FIG. 22 depicts one embodiment the logic associated with the multicast pattern generation process of FIG. 6, in accordance with an aspect of the present invention;

FIGS. 23A-23B depict one embodiment of the logic associated with selecting and downloading multicast lookup table values to switches, in accordance with an aspect of the present invention; and

FIG. 24 depicts one embodiment of a computer program product embodying one or more aspects of the present invention.

### BEST MODE FOR CARRYING OUT THE INVENTION

In accordance with an aspect of the present invention, efficient, reliable broadcast support is provided to clients of a network built using switching elements that have the capability to replicate packets. With this support, each network host is able to broadcast to each network host of, for instance, a broadcast domain every time a broadcast is attempted. Further, the management of replication paths in the network is transparent to the hosts; the receivers do not receive any duplicate packets from any sender; and no broadcast hotspots are created in the network.

As used herein, “broadcast domain” includes all nodes (or hosts) that should receive a broadcast and/or send a broadcast.

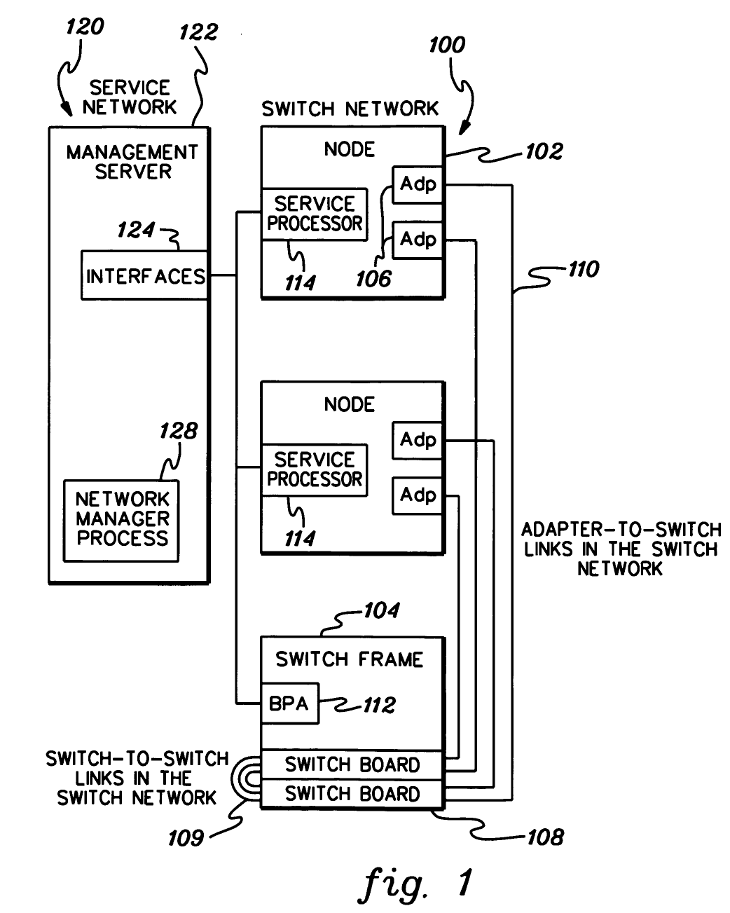

One embodiment of a communications network incorporating and using one or more aspects of the present invention is described with reference to FIG. 1. A communications network 100 is, for instance, a switch network that may be optical, copper, phototonic, etc., or any combination thereof. As is known, a switch network is used in communicating between computing units (e.g., processors) of a system, such as a central processing complex or a cluster. The processors may be, for instance, pseries® processors, offered by International Business Machines Corporation, Armonk, N.Y. and/or other processors. One switch network offered by International Business Machines Corporation is the High Performance Switch (HPS) network, an embodiment of which is described in “An Introduction to the New IBM eServer pSeries High Performance Switch,” SG24-6978-00, December 2003, which is hereby incorporated herein by reference in its entirety. (“IBM” and “pSeries” are registered trademarks of International Business Machines Corporation, Armonk, N.Y., U.S.A. Other names used herein may be registered trademarks, trademarks or product names of International Business Machines Corporation or other companies.)

Switch network 100 includes, for example, a plurality of nodes 102, such as Power 4 nodes offered by International Business Machines Corporation, Armonk, N.Y., coupled to one or more switch frames 104. A node 102 includes, as an example, one or more adapters 106 coupling nodes 102 to switch frame 104. Switch frame 104 includes, for instance, a plurality of switch boards 108, each of which is comprised of one or more switch chips or switching elements. Each switch chip includes one or more external switch ports, and optionally, one or more internal switch ports. A switch board 108 is coupled to one or more other switch boards via one or more switch-to-switch links 109 in the switch network. Further, one or more switch boards are coupled to one or more adapters of one or more nodes of the switch network via one or more adapter-to-switch links 110 of the switch network.

Although in the example described herein the switch boards are coupled to adapters, in other examples, the switch boards may be coupled to other network interfaces via interface-to-switch links in the switch network. An adapter is one example of a network interface.

Switch frame 104 also includes at least one bulk power assembly 112 coupling the switch frame to a service network 120. Similarly, a node 102 includes, for instance, one or more service processors 114 coupling the node to service network 120. The bulk power assembly may include a service processor. The service processors include logic used at initialization. In a further embodiment, one or more of the service processors or bulk power assemblies may be replaced with other types of links.

Service network 120 is an out-of-band network that provides various services to the switch network. For example, the service network is responsible for facilitating reliable broadcasting in the network, in accordance with an aspect of the present invention. In one example, service network 120 includes a management server 122 having, for instance, one or more interfaces 124 (e.g., Ethernet adapters), which are coupled to one or more service processors 114 of nodes 102 and/or one or more bulk power assemblies 112 of switch frame 104. Management server 122 executes at least one network manager process 128 (also referred to herein as the network manager).

The network manager is responsible for various tasks, including exploring the network, initializing it and maintaining the network. When network exploration is complete, the network manager completes its device database with information about connectivity, as well as the status of devices and links. At this point, the network manager is ready to compute multicast lookup table (MLT) entries (described below) and place them in the MLTs on switch chips, in accordance with an aspect of the present invention. In one example, four distinct MLT entries are placed on switch chips whenever possible, since the adapters currently support four multicast routes. The MLT entries are used in facilitating reliable broadcast within the switch network, as described below.

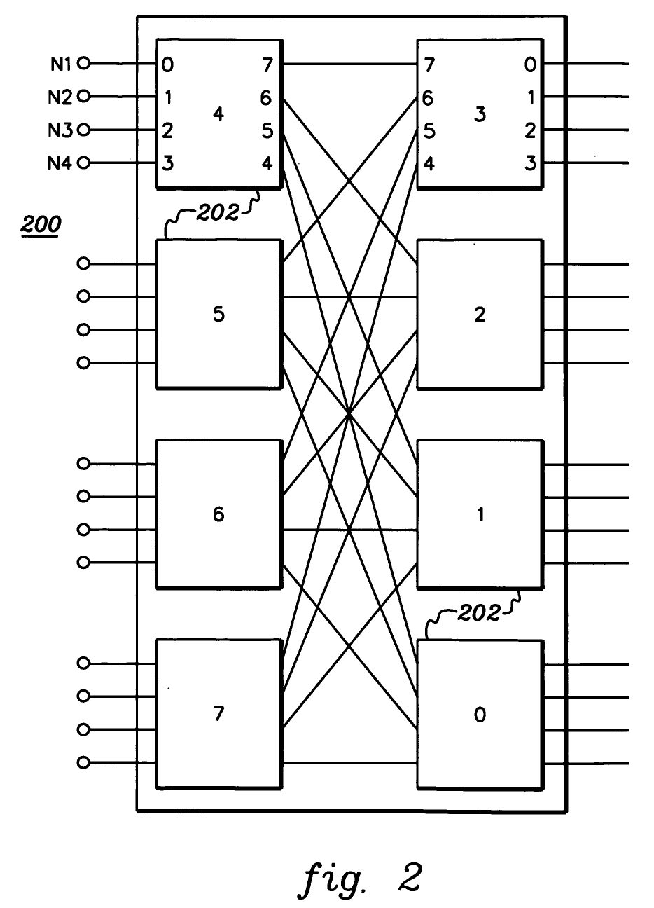

Further details regarding the switch network, and in particular, switch board 108, are now provided. One embodiment of a switch board, generally denoted 200, is depicted in FIG. 2. This switch board includes, for instance, eight switch chips 202, labeled chip 0-chip 7. As one example, chips 4-7 are assumed to be linked to nodes, with four nodes (i.e., N1-N4) labeled. Since switch board 200 is assumed to connect to nodes, the switch board comprises a node switch board or NSB.

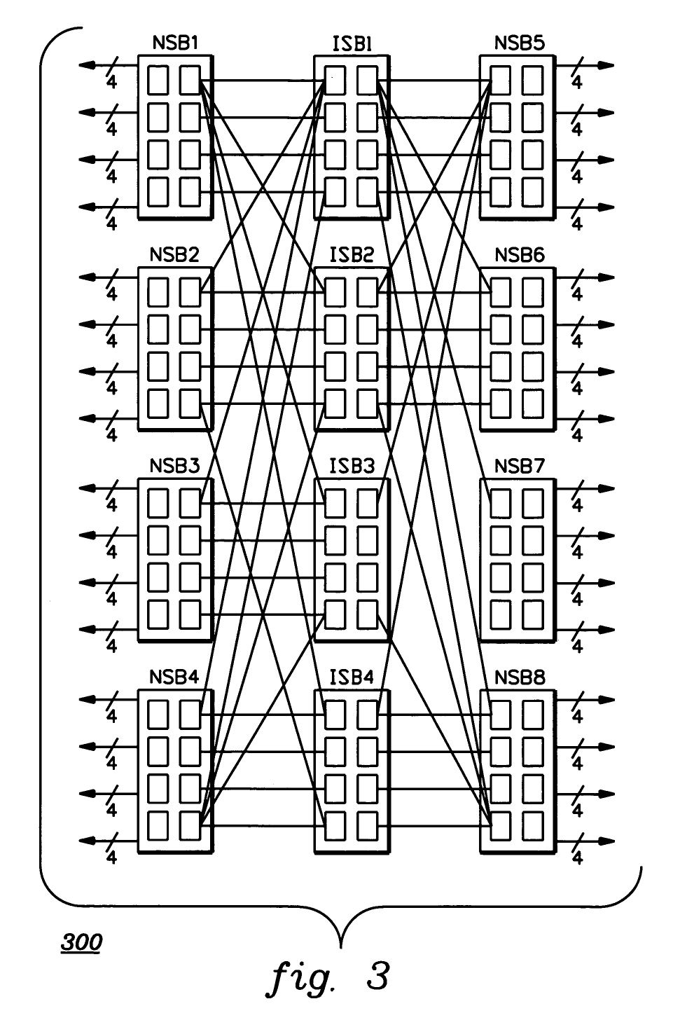

FIG. 3 depicts one embodiment of a logical layout of switch boards in a 128-node system 300. Within system 300, switch boards connected to nodes are node switch boards (labeled NSB1-NSB8), while switch boards that link the NSBs are intermediate switch boards (labeled ISB1-ISB4). Each output of NSB1-NSB8 can connect to, for instance, four nodes.

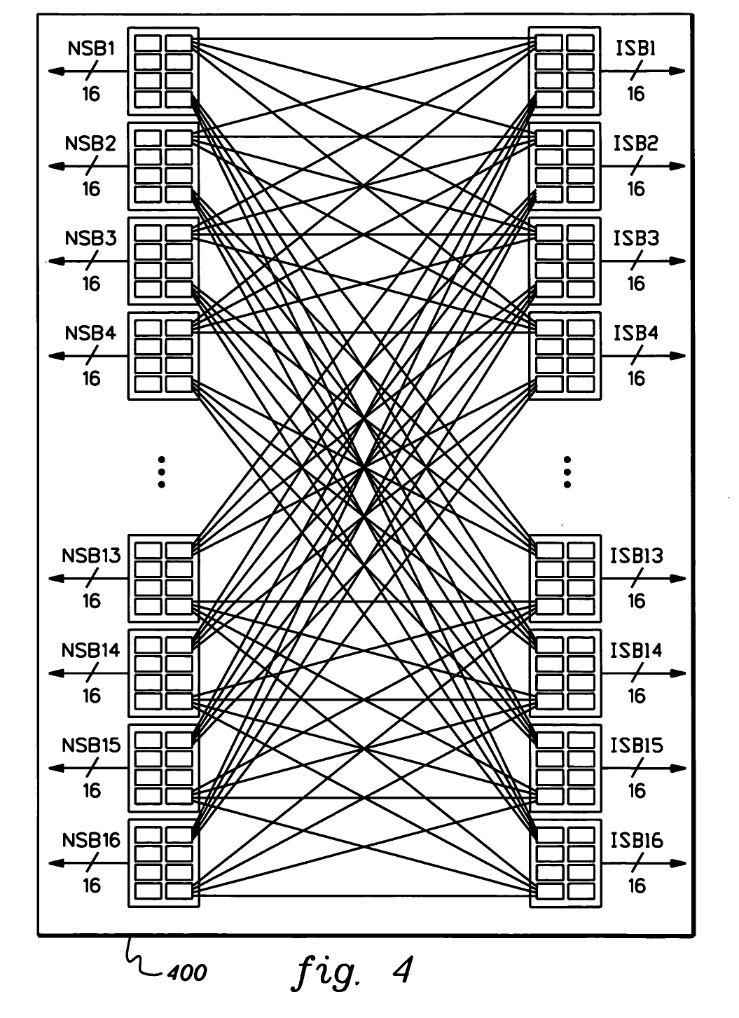

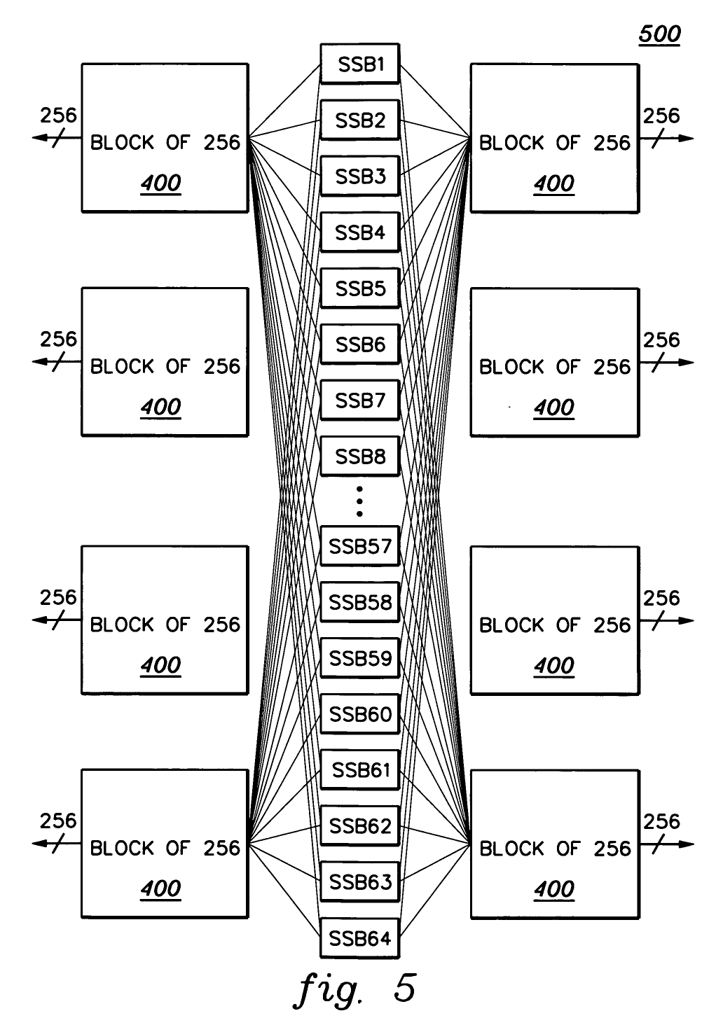

FIGS. 4 & 5 illustrate a large multi-stage network in which host nodes are connected on the periphery of the network, on the left and right sides of FIG. 5. This network includes sets of switch boards interconnected by links in a regular pattern. As shown in FIG. 4, the boards themselves contain eight switch chips, which form two stages of switching. The routes between source-destination pairs in this network are passed through multiple switch chips ranging from 1 to 10. In FIG. 4, a switch block of 256 endpoints 400 is illustrated wherein both node switch boards (NSBs) and intermediate switch boards (ISBs) are employed. Since each board can connect to 16 possible nodes, switch block 400 is referred to as a 256 endpoint switch block. This block is then repeated eight times in the network of FIG. 5 to arrive at a 2048 endpoint network 500. The switch blocks 400 of 256 endpoints are interconnected via 64 secondary stage boards (SSBs), which are similar to the intermediate switch boards, and have similar internal chips and connections. (In the above figures, not all of the connections are shown, for clarity.)

The switch chips in the network are classified into different levels. Level 1 chips are the chips connected to the hosts; level 2 chips are the chips connected to level 1 chips on one side; level 3 are those connected to level 2 chips on one side, and so on. The root chips are those that belong to the highest level of switch chips. By this classification, a network with one switch board has two levels; the network of FIG. 2 has three levels; and the network of FIG. 3 has five levels. It is possible to have topologies that have four levels or more than five levels.

A switch chip on the High Performance Switch has, for instance, eight ports, such that four of them connect to lower level chips and are called inbound ports and the other four connect to higher level chips and are called outbound ports.

In accordance with an aspect of the present invention, the switch chips have the capability to replicate incoming packets and send them out through multiple ports. In particular, each switch chip includes logic that replicates an incoming packet through either of two port sets (inbound or outbound) on the chip and sends them out through the ports indicated in a replication pattern stored on the switch chip. The replication pattern for each set of ports is, for instance, a group of nine bits. The first bit, when set to one, indicates to the hardware that the incoming packet needs to be replicated as many times as there are ones in the following eight bits (which refer to ports 0-7). Any of the eight bits are set to 1 if the incoming packet is to be replicated and sent out of the port represented by the corresponding bit. These patterns are stored in a multicast look-up table (MLT). Each entry in the table includes one nine bit pattern for each of the two port groups. These patterns can be set up while initializing the switch and can be modified dynamically during network operation.

An incoming multicast packet is sent by the host with a look-up table index. The incoming packet includes data, but no destination address. On receiving a multicast packet, a switch chip accesses the MLT entry corresponding to the index placed in the packet by the host, replicates the packet as necessary or desired, and sends the replicated packets out through the desired ports. There is no other address information in the multicast packet.

In order to provide reliable global broadcast, in accordance with an aspect of the present invention, the MLT entries are to be set up to ensure connectivity. That is, replication patterns are to be generated that enable any source to broadcast to, for instance, all destinations in the network. Further, patterns are generated such that a receiver of data does not receive duplicate data from a sender.

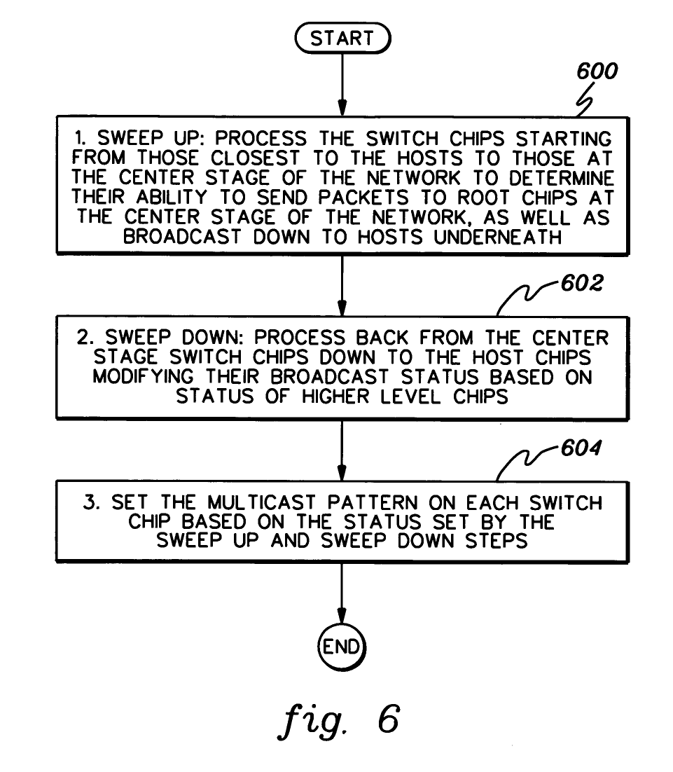

One embodiment of the logic associated with generating such replication patterns is described with reference to FIG. 6. Initially, a sweep up process is performed, STEP 600. During the sweep up, the switch chips are processed starting from the closest to the host to those at the center stage of the network to determine their ability to send packets to root chips at the center stage of the network, as well as their ability to broadcast down to hosts underneath.

Additionally, a sweep down process is performed, in which the switch chips are processed back from the center stage switch chips down to the host chips, modifying their broadcast status based on status of higher level chips, STEP 602. The sweep up and sweep down processes determine the ability of the switch chip to broadcast packets.

Thereafter, based on the statuses obtained by sweep up and sweep down, a multicast pattern is set on each switch chip, STEP 604. The multicast pattern is set such that, for instance, every network host is able to broadcast to every other network host; the receivers do not receive any duplicate packets from any sender; and no broadcast hotspots are created in the network.

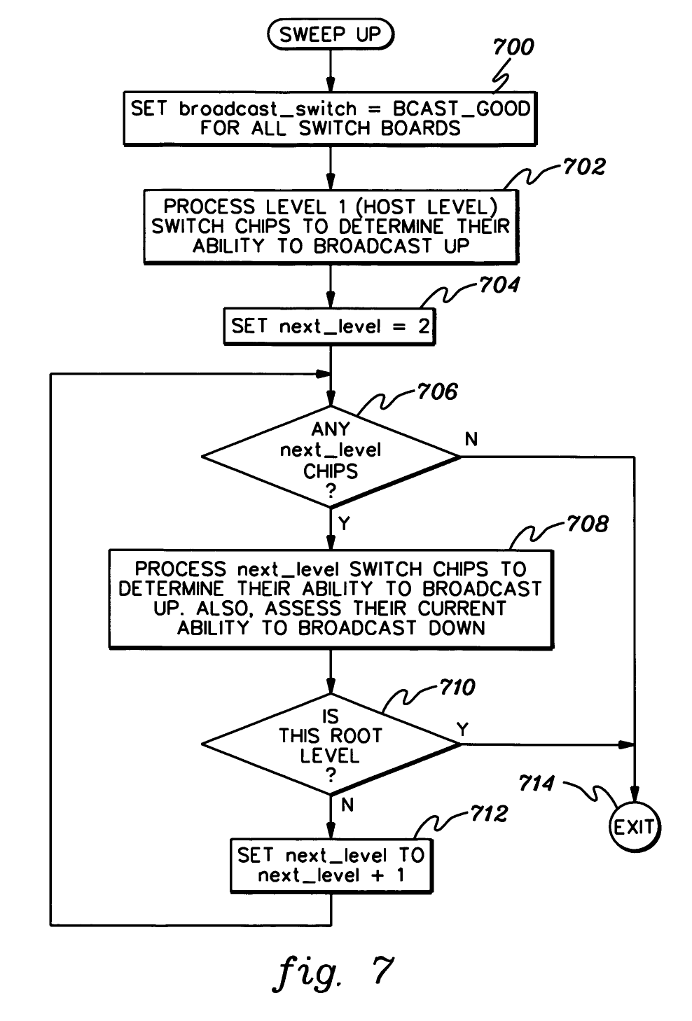

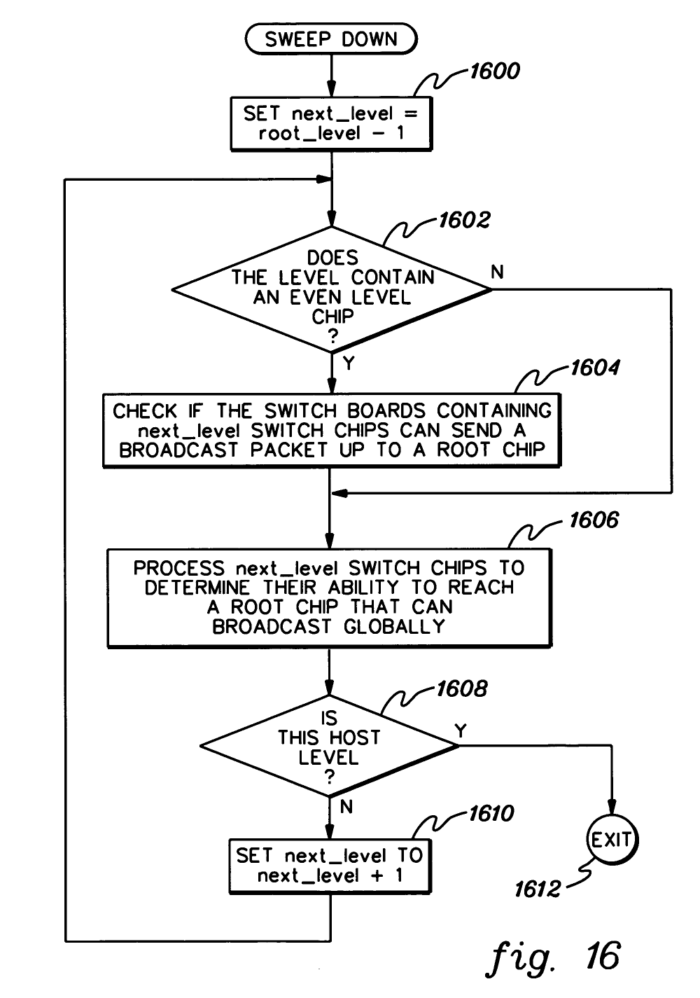

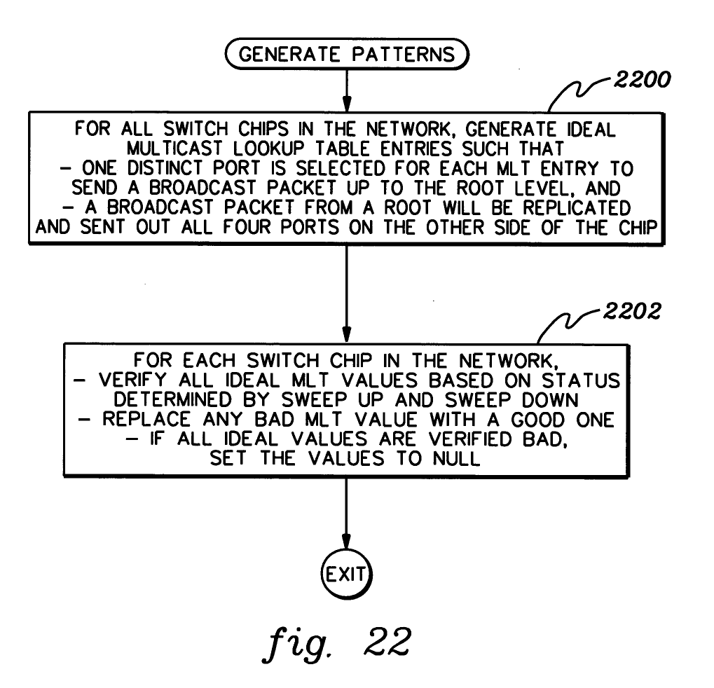

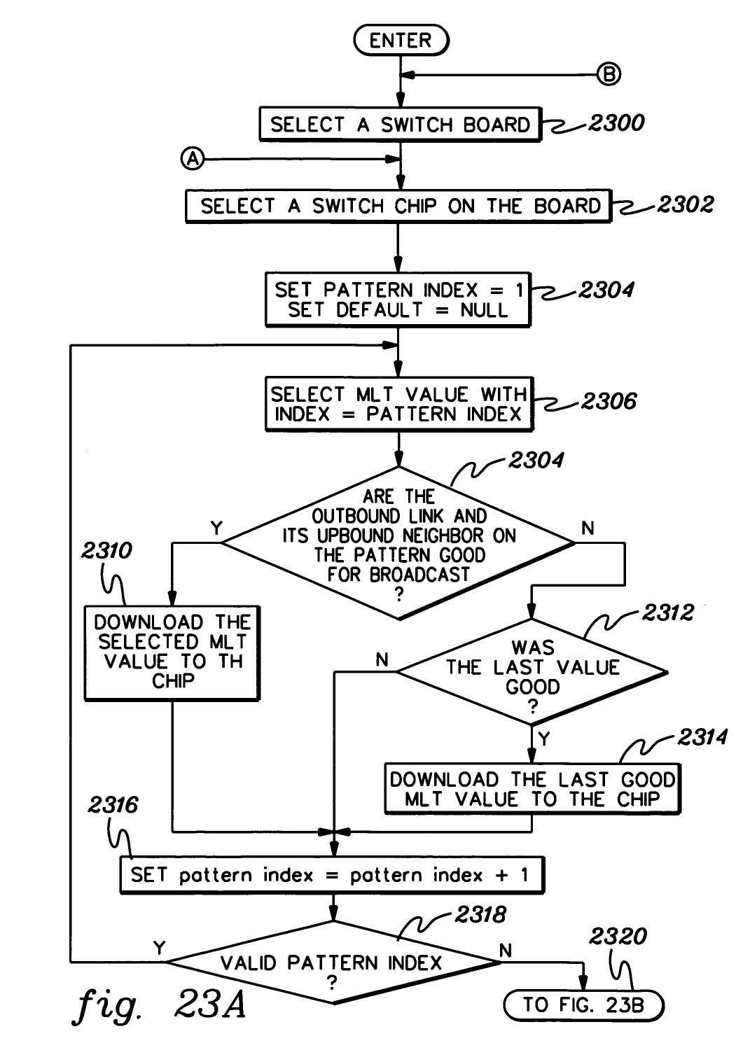

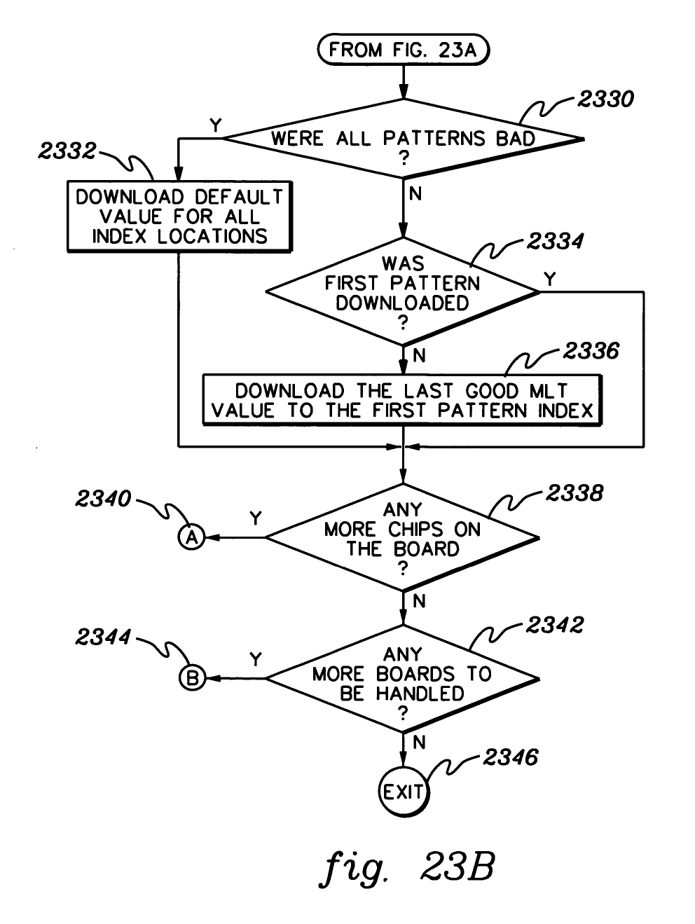

Further details regarding each of these steps are described below. In particular, details associated with the sweep up process are described with reference to FIGS. 7-15B; details associated with the sweep down process are described with reference to FIGS. 16-21; and details associated with generating the multicast patterns are described with reference to FIGS. 22-23. The logic of these figures is performed by, for instance, the network manager. In other embodiments, however, one or more other entities perform this logic.

Referring initially to the sweep up process, and in particular, to FIG. 7, the logic commences with initializing a variable, referred to as broadcast_switch, to BCAST_GOOD for all switch boards of the network, STEP 700. Thereafter, level 1 switch chips (host level) are processed to determine their ability to broadcast up, STEP 702, as described in further detail below. Additionally, a variable, next_level, is set to level 2, STEP 704, and a determination is made as to whether there are any next_level chips, INQUIRY 706. If there are next_level chips, then the next_level switch chips are processed to determine their ability to broadcast, STEP 708, as described further below. Thereafter, a determination is made as to whether this is the root level, STEP 710. If it is not the root level, then next_level is incremented by one, STEP 712, and processing continues with INQUIRY 706. Otherwise, or if there are no more next level chips, then the sweep up processing is complete, STEP 714.

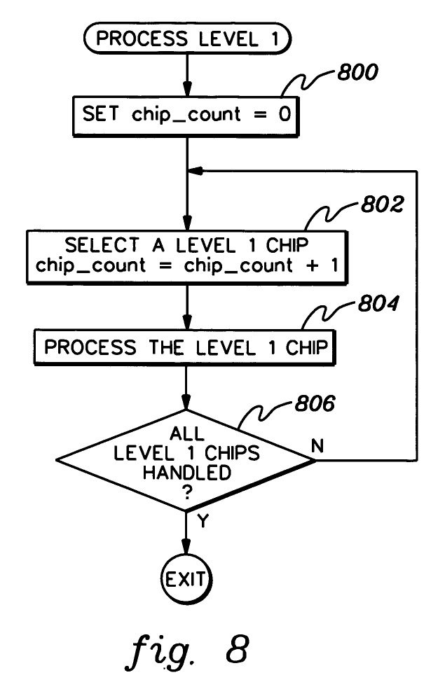

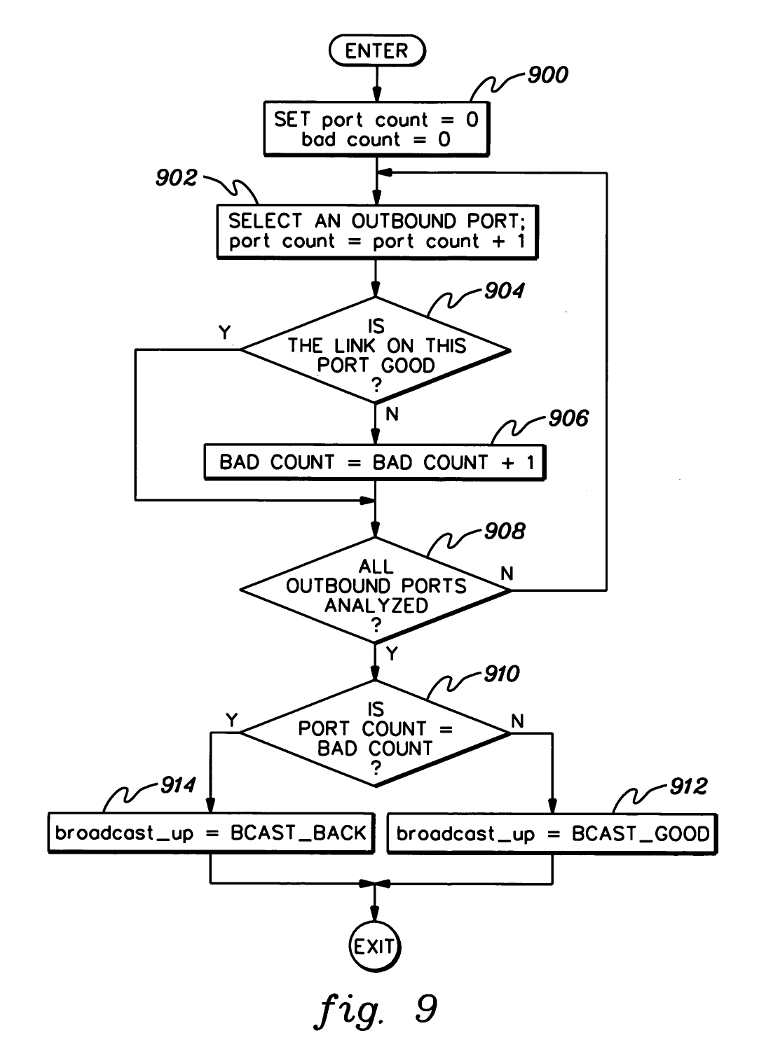

Further details regarding one embodiment of the processing of level 1 chips are described with reference to FIGS. 8 and 9. Referring initially to FIG. 8, a variable referred to as chip_count is set equal to zero, STEP 800. Then, a level 1 chip is selected and chip_count is incremented by one, STEP 802. The selected level 1 chip is processed, STEP 804, as described below with reference to FIG. 9. Thereafter, a determination is made as to whether all the level 1 chips have been processed, INQUIRY 806. If there are more level 1 chips to be processed, then processing continues with STEP 802. Otherwise, the level 1 processing is complete.

Referring to FIG. 9, one embodiment of the logic associated with processing level 1 chips is described. Initially, a port count and a bad count are initialized to zero, STEP 900. Then, an outbound port of the chip is selected and the port count is incremented by one, STEP 902. A determination is made as to whether the link on this port is good, INQUIRY 904. In one example, this determination is made by checking the status of the link maintained by the network manager. Further, in one particular embodiment, this determination is described in “Facilitating Detection Of Hardware Service Actions,” Atkins et al., U.S. Ser. No. 11/223,322, filed Sep. 8, 2005, which is hereby incorporated herein by reference in its entirety.

If the link is bad, then the bad count is incremented by one, STEP 906. Thereafter, or if the link is good, a determination is made as to whether all the outbound ports have been analyzed, INQUIRY 908. If all the outbound ports have not been analyzed, then processing continues with STEP 902. Otherwise, an inquiry is made into whether the port count is equal to the bad count, INQUIRY 910. If the port count is not equal to the bad count, then a variable, broadcast_up, is set equal to BCAST_GOOD, STEP 912, indicating that the chip is able to broadcast up. However, if the port count is equal to the bad count, then broadcast_up is set equal to BCAST_BACK, STEP 914, indicating the chip state is bad for broadcast up, but is able to broadcast down. This completes processing of the level 1 chips.

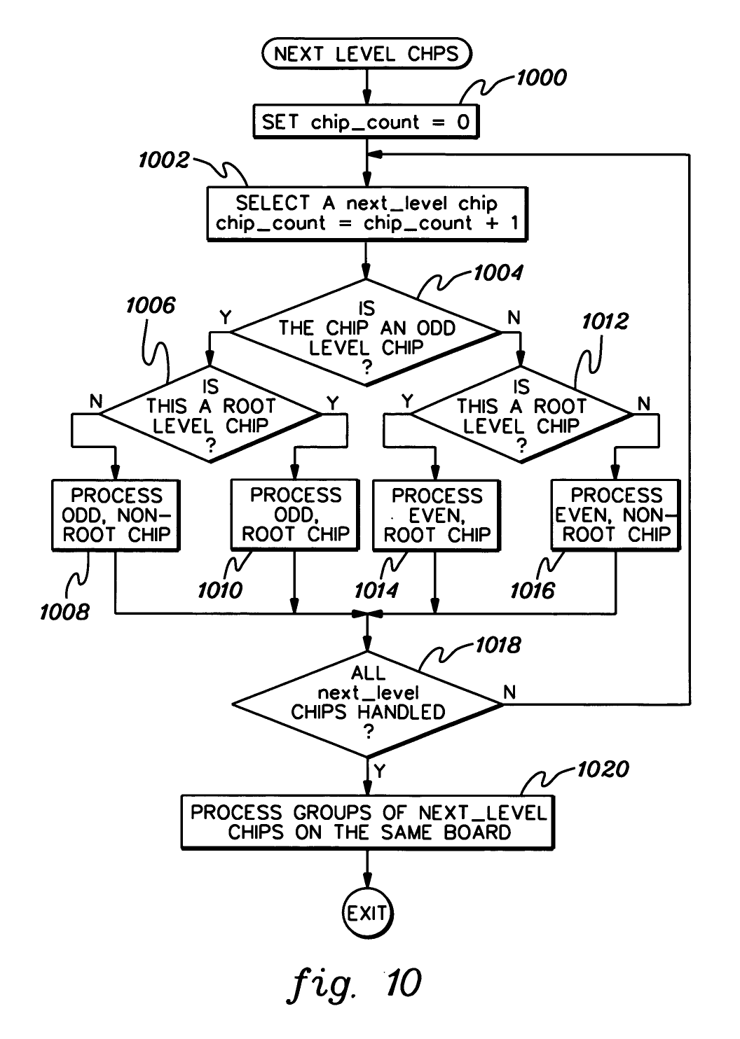

In addition to processing the level 1 chips, the next_level switch chips are also processed (STEP 708, FIG. 7). One embodiment of the logic associated with processing the next level switch chips is described with reference to FIGS. 10-15.

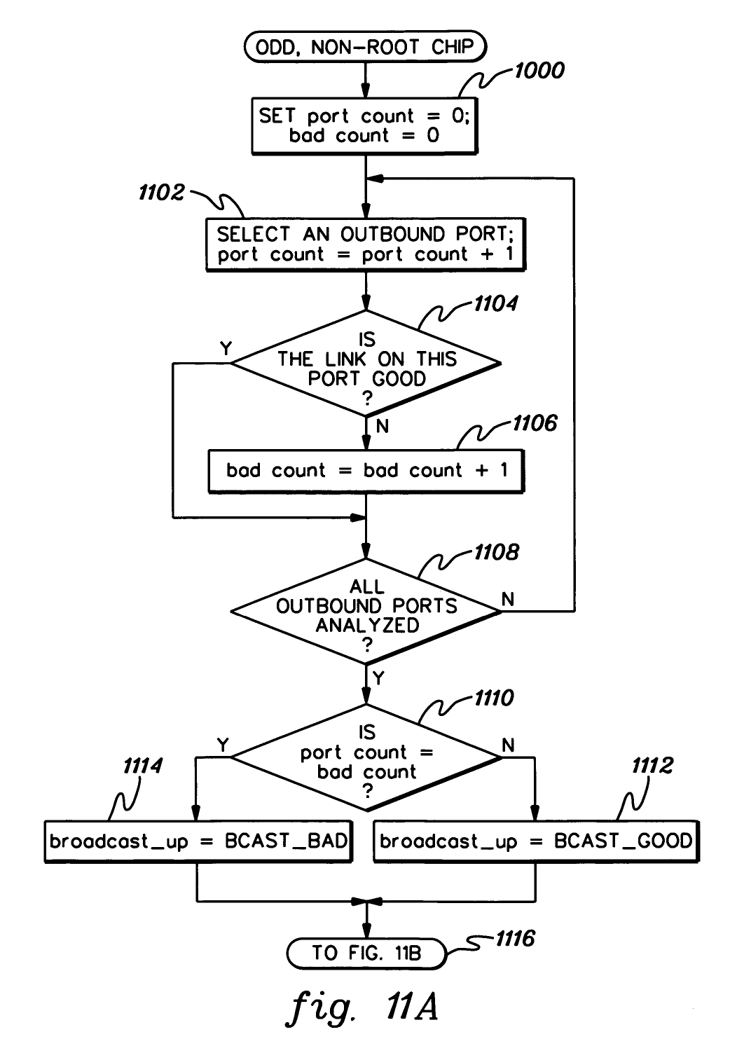

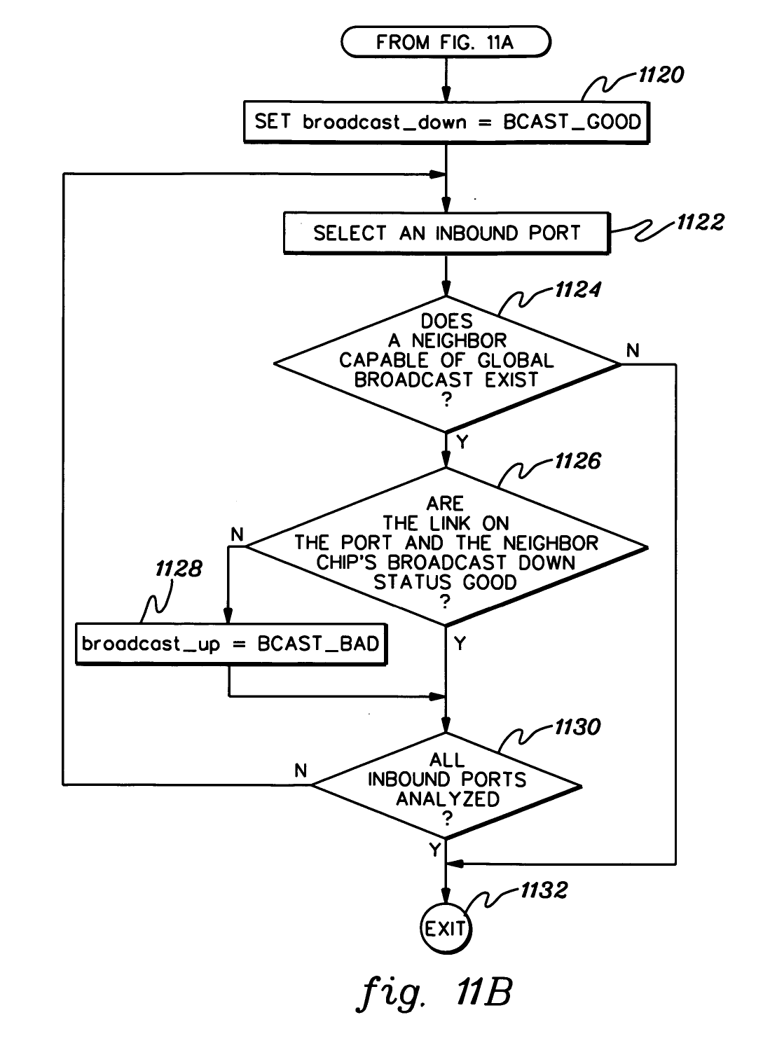

Referring to FIG. 10, initially, chip_count is initialized to zero, STEP 1000, a next_level chip is selected and the chip count is incremented by 1, STEP 1002. Thereafter, a determination is made as to whether the selected chip is an odd level chip, INQUIRY 1004. If it is an odd level chip, then a further inquiry is made as to whether it is a root level chip, INQUIRY 1006. Should this chip be an odd level chip, but not a root level chip, then processing continues with FIG. 11A, STEP 1008.

Referring to FIG. 11A, to process an odd non-root chip, initially, the port count and bad count are initialized to zero, STEP 1100. Then, an outbound port of the chip is selected and the port count is incremented by one, STEP 1102. A determination is made as to whether the link on this port is good, INQUIRY 1104. If the link is not good, then the bad count is incremented by one, STEP 1106. Subsequently, or if the link on the port is good, then a further determination is made as to whether all the outbound ports have been analyzed, INQUIRY 1108. If they have not all been analyzed, then processing continues with STEP 1102. However, after all of the outbound ports have been analyzed, then a determination is made as to whether the port count is equal to the bad count, INQUIRY 1110. If the port count is not equal to the bad count, then broadcast_up is set equal to BCAST_GOOD, STEP 1112. Otherwise, broadcast_up is set equal to BCAST_BAD, STEP 1114.

Subsequent to setting the broadcast_up variable, processing continues with analyzing whether the chip can broadcast down, STEP 1116. Initially, a variable referred to as broadcast_down is initialized to BCAST_GOOD, STEP 1120. Thereafter, an inbound port of the chip is selected, STEP 1122, and a determination is made as to whether a neighbor capable of global broadcast exists, INQUIRY 1124. In one example, this determination is made by checking whether the chip is connected to any lower level chip (i.e., any chip connected to the inbound port). If a neighbor capable of global broadcast exists, then a further determination is made as to whether the link on the port and the neighbor chip's broadcast down status are good, INQUIRY 1126. If either one is bad, then broadcast_down is set equal to BCAST_BAD, STEP 1128. Thereafter, or if both are good, then a check is made as to whether all inbound ports of the chip have been analyzed, INQUIRY 1130. Should there be more inbound ports to be analyzed, then processing continues with STEP 1122. Otherwise, or if a neighbor capable of global broadcast does not exist, processing of an odd non-root chip is complete, STEP 1132.

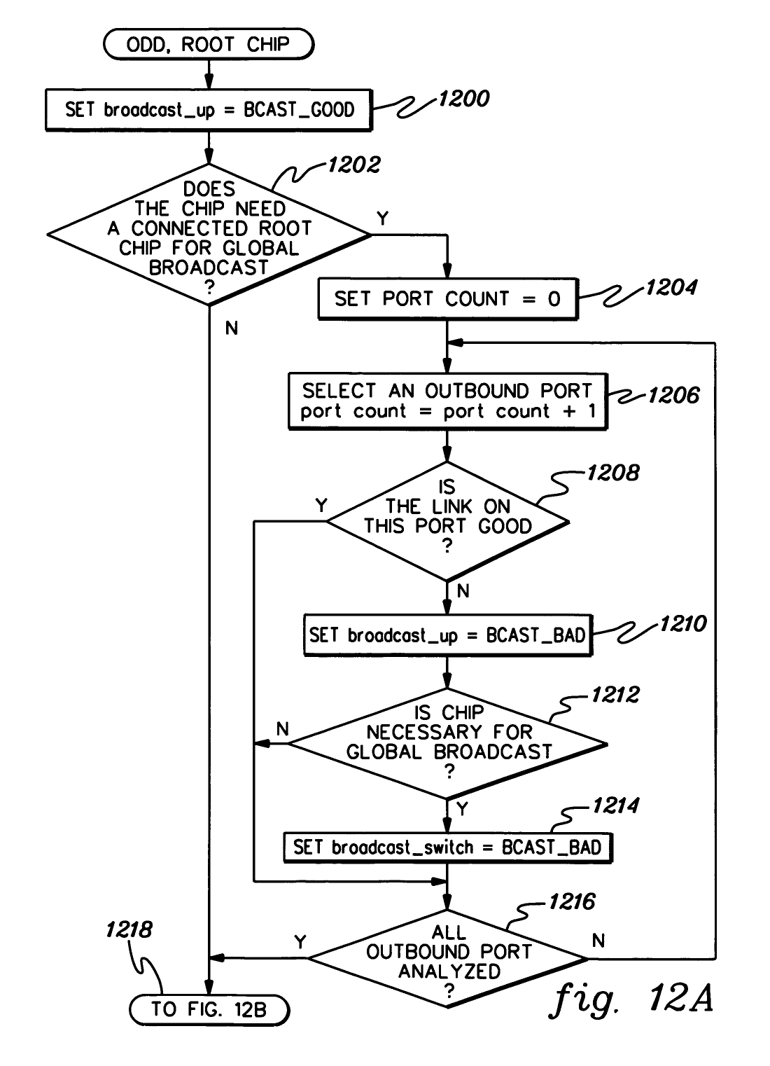

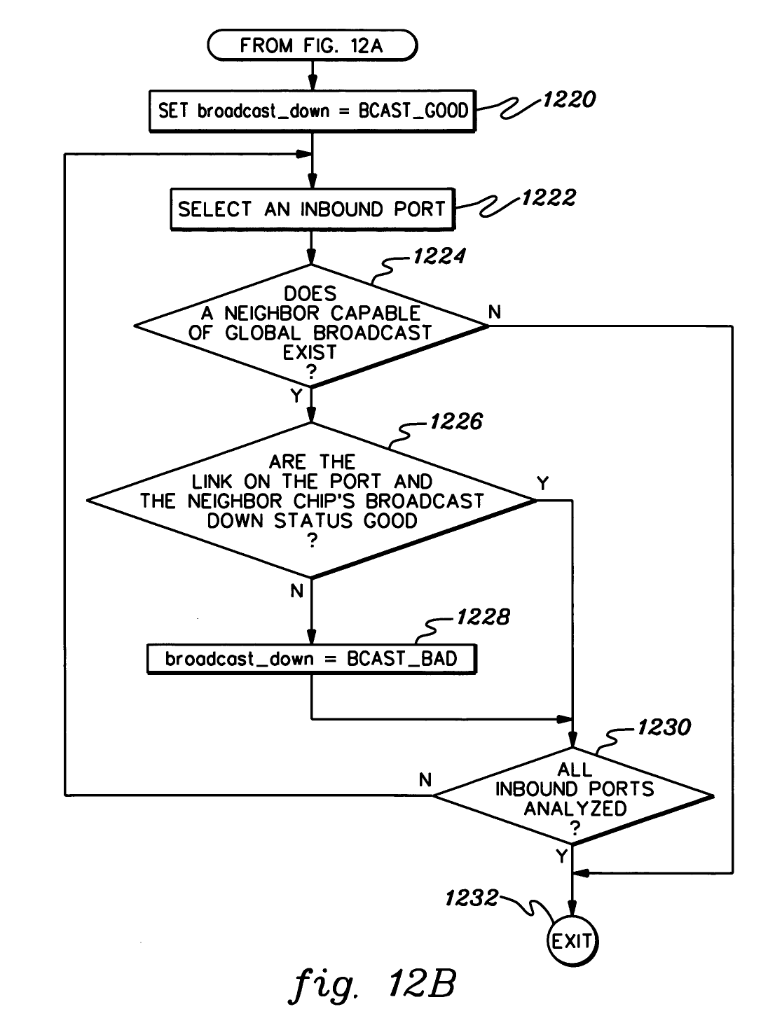

Returning to FIG. 10, if it is determined that the selected chip is an odd level chip, INQUIRY 1004, and a root level chip, INQUIRY 1006, then processing continues with processing an odd root chip, STEP 1010. One embodiment of this processing is described with reference to FIGS. 12A-12B.

Referring to FIG. 12A, broadcast_up is initialized to BCAST_GOOD, STEP 1200. Thereafter, a determination is made as to whether the chip needs a connected root chip for global broadcast, INQUIRY 1202. For example, a check is made as to whether any other chip on the same board connected to this root chip is also a root chip. If it is, then the chip needs a connected root chip. If the chip needs a connected root chip for global broadcast, then the port count is set equal to zero, STEP 1204, an outbound port of the chip is selected and the port count is incremented by one, STEP 1206. Thereafter, a determination is made as to whether the link on this port is good, INQUIRY 1208. If the link on this port is not good, then broadcast_up is set equal to BCAST_BAD, STEP 1210. Further, an inquiry is made as to whether this chip is necessary for global broadcast, INQUIRY 1212. In one example, the chip is necessary for broadcast if it has at least one link that leads to at least one port while broadcasting down. Should the chip be necessary for global broadcast, broadcast_switch is set equal to BCAST_BAD, STEP 1214. Thereafter, or if the link on this port is good, or if the chip is not necessary for global broadcast, a determination is made as to whether all outbound ports of the chip have been analyzed, INQUIRY 1216. If there are more outbound ports to be analyzed, then processing continued with STEP 1206. Otherwise, or if the chip does not need a connected root chip for global broadcast, INQUIRY 1202, processing continues with FIG. 12B, STEP 1218, to determine whether the chip can broadcast down.

Referring to FIG. 12B, initially broadcast_down is set equal to BCAST_GOOD, STEP 1220. Thereafter, an inbound port is selected, STEP 1222, and a determination is made as to whether a neighbor capable of global broadcast exists, INQUIRY 1224. If a neighbor capable of global broadcast does exist, then a further determination is made as to whether the link on the port and the neighbor chip's broadcast down status are good, INQUIRY 1226. If either one is bad, then broadcast_down is set equal to BCAST_BAD, STEP 1228. Thereafter, or if the link and the neighbors chip's broadcast down status are good, then a determination is made as to whether all the inbound ports of the chip have been analyzed, INQUIRY 1230. If there are more inbound ports to be analyzed, then processing continues with STEP 1222. Otherwise, or if a neighbor capable of global broadcast does not exist, then processing of an odd root chip is complete, STEP 1232.

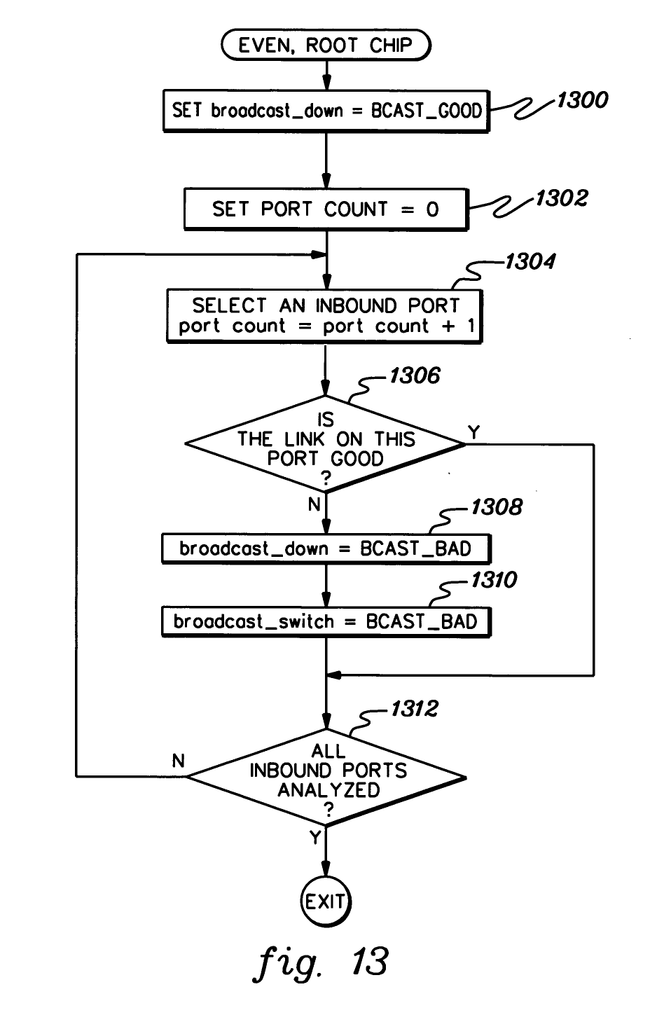

Returning to INQUIRY 1004 of FIG. 10, if this chip is not an odd level chip, then it is an even level chip, and a further determination is made as to whether it is a root level chip, INQUIRY 1012. If it is a root level chip, then the even root chip is processed, STEP 1014. One embodiment of the logic associated with processing an even root chip is described with reference to FIG. 13.

Initially, broadcast_down is set equal to BCAST_GOOD, STEP 1300, and the port count is set equal to zero, STEP 1302. Then, an inbound port is selected and the port count is incremented by one, STEP 1304. A determination is made as to whether the link on this port is good, INQUIRY 1306. If the link is not good, then broadcast_down is set equal to BCAST_BAD, 1308, as well as broadcast_switch, STEP 1310. Thereafter, or if the link on this port is good, a determination is made as to whether all inbound ports of the chip have been analyzed, INQUIRY 1312. If there are more inbound ports to be analyzed, then processing continues with STEP 1304. Otherwise, processing of an even root chip is complete.

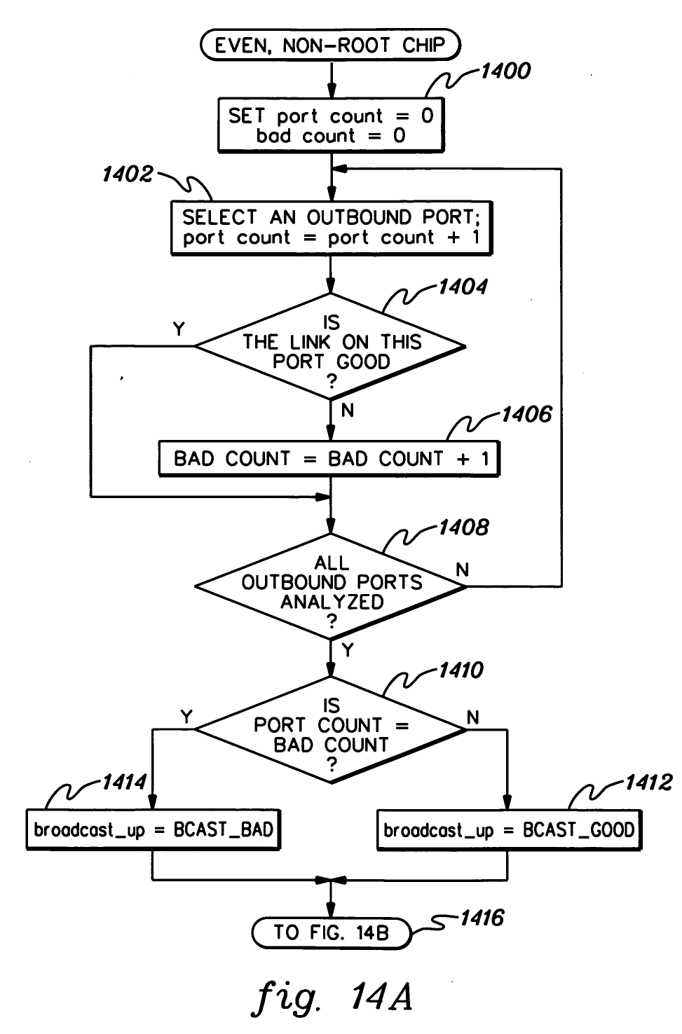

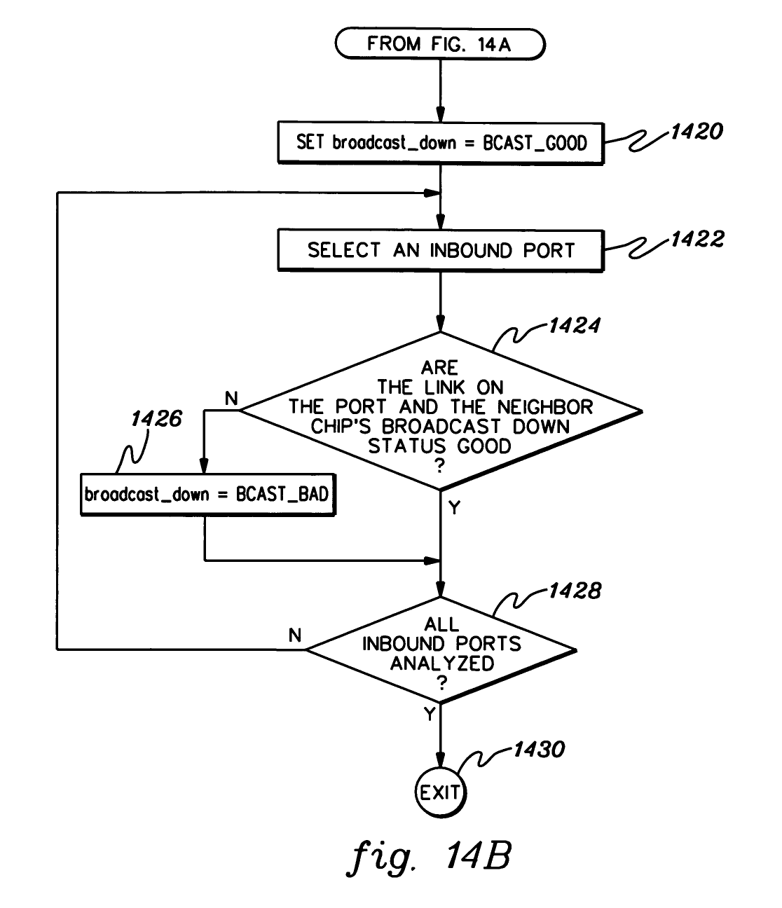

Returning to INQUIRY 1012 of FIG. 10, if the selected chip is not a root chip, then the even non-root chip is processed, STEP 1016. One embodiment of the logic associated with processing an even non-root chip is described with reference to FIGS. 14A-14B.

Referring to FIG. 14A, initially, the port count is set equal to zero, as well as the bad count, STEP 1400. Thereafter, an outbound port is selected and the port count is incremented by one, STEP 1402. A determination is made as to whether the link on this port is good, INQUIRY 1404. If the link is not good, then the bad count is incremented by 1, STEP 1406. Thereafter, or if the link is good, a determination is made as to whether all outbound ports of the chip have been analyzed, INQUIRY 1408. If there are more outbound ports to be processed, then processing continues with STEP 1402. Otherwise, a determination is made as to whether the port count is equal to the bad count, INQUIRY 1410. If the port count is equal to the bad count, then broadcast_up is set equal to BCAST_BAD, STEP 1414. However, if the port count does not equal the bad count, then broadcast_up is set equal to BCAST_GOOD, STEP 1412. After setting the broadcast_up variable, processing continues with STEP 1416 to determine whether the selected chip can broadcast down.

With reference to FIG. 14B, broadcast_down is initialized to BCAST_GOOD, STEP 1420, and an inbound port is selected, STEP 1422. Thereafter, a determination is made as to whether the link on the port and the neighbor chip's broadcast down status are good, INQUIRY 1424. If they are not good, then broadcast_down is set equal to BCAST_BAD, STEP 1426. Thereafter, or if the link and the neighbors chip's broadcast down status are good, a determination is made as to whether all inbound ports have been analyzed, STEP 1428. If there are more inbound ports to be analyzed, then processing continues with STEP 1422. Otherwise, processing of an even non-root chip is complete, STEP 1430.

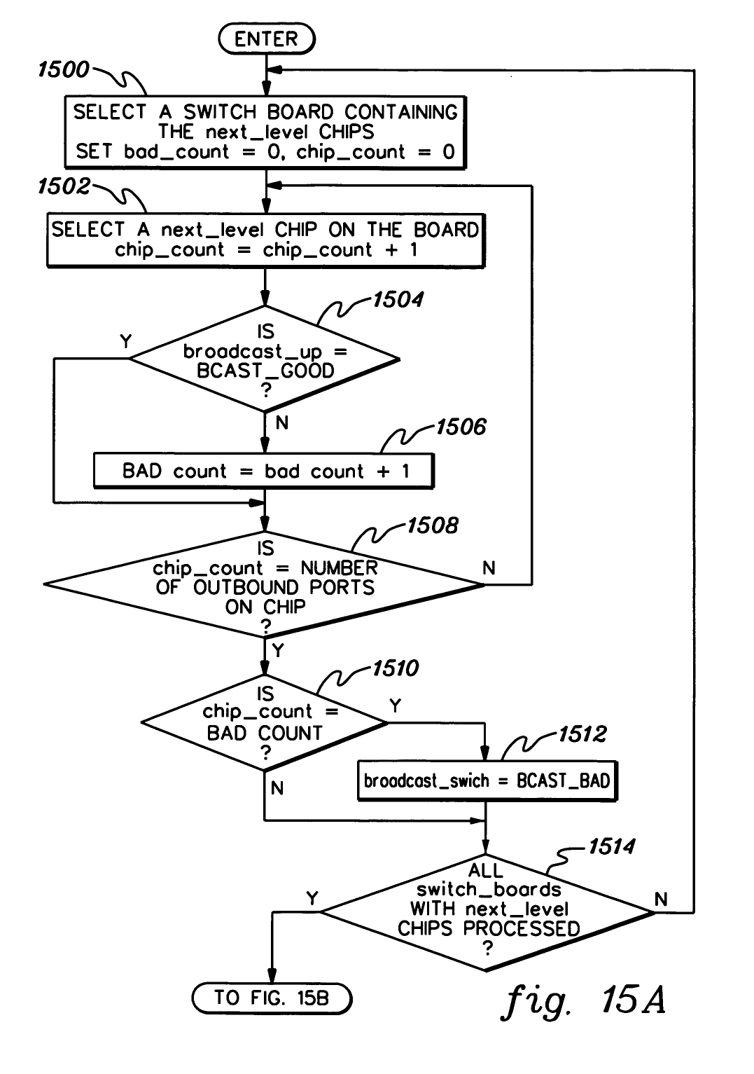

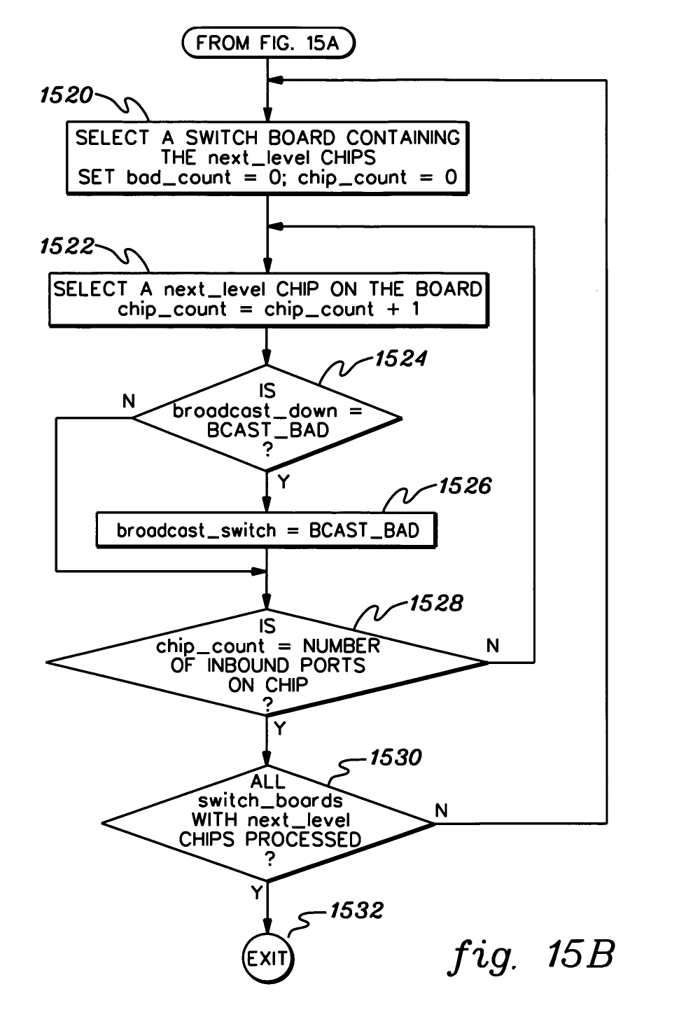

Returning to FIG. 10, after processing the selected next_level chip, a determination is made as to whether all the next_level chips have been processed, INQUIRY 1018. If not, then processing continues with STEP 1002 to select another next_level chip. However, if the next_level chips have been processed, then groups of next level chips on the same board are processed, STEP 1020. One embodiment of this processing is described with reference to FIGS. 15A-15B.

Referring initially to FIG. 15A, a switch board containing the next_level chips is selected, and the bad count and the chip count are initialized to zero, STEP 1500. A next_level chip on the board is then selected, and the chip count is incremented by one, STEP 1502. Thereafter, a determination is made as to whether broadcast_up for this chip is equal to BCAST_GOOD, INQUIRY 1504. If they are not equal, then the bad count is incremented by one, STEP 1506. Thereafter, or if broadcast_up is equal to BCAST_GOOD, then a determination is made as to whether the chip count is equal to the number of outbound ports on the chip, INQUIRY 1508. If not, then processing continues with STEP 1502. Otherwise, processing continues with determining whether the chip count is equal to the bad count, INQUIRY 1510. Should the chip count be equal to the bad count, then broadcast_switch is set equal to BCAST_BAD, STEP 1512. Thereafter, or if the chip count is not equal to the bad count, a determination is made as to whether all switch boards with next_level chips have been processed, INQUIRY 1514. If there are more switch boards with next_level chips to be processed, then processing continues with STEP 1500. Otherwise, processing continues with FIG. 15B.

Referring to FIG. 15B, a switch board containing the next_level chips is selected, and the bad count and chip count are initialized to zero, STEP 1520. A next_level chip on the board is selected and the chip count is incremented by one, STEP 1522. Thereafter, a determination is made as to whether broadcast_down is equal to BCAST_BAD, indicating the chip cannot be used for broadcast, INQUIRY 1524. If so, then broadcast_switch is set equal to BCAST_BAD, STEP 1526. Thereafter, or if broadcast_down is not equal to BCAST_BAD, a determination is made as to whether the chip count is equal to the number of inbound ports on the chip, INQUIRY 1528. If not, then processing continues with STEP 1522. Otherwise, a determination is made as to whether all switch boards with next_level chips have been processed, INQUIRY 1530. If there are more switch boards to be processed, then processing continues with STEP 1520. Otherwise, processing of chips at the same level on the same board is complete, STEP 1532.

Described in detail above is the sweep up process, which processes the switch chips staring from those closest to the hosts to those at the center stage of the network to determine their ability to send packets to root chips, as well as to broadcast down to hosts underneath. Next, further details are described regarding the sweep down process, which processes center stage switch chips back to the hosts.

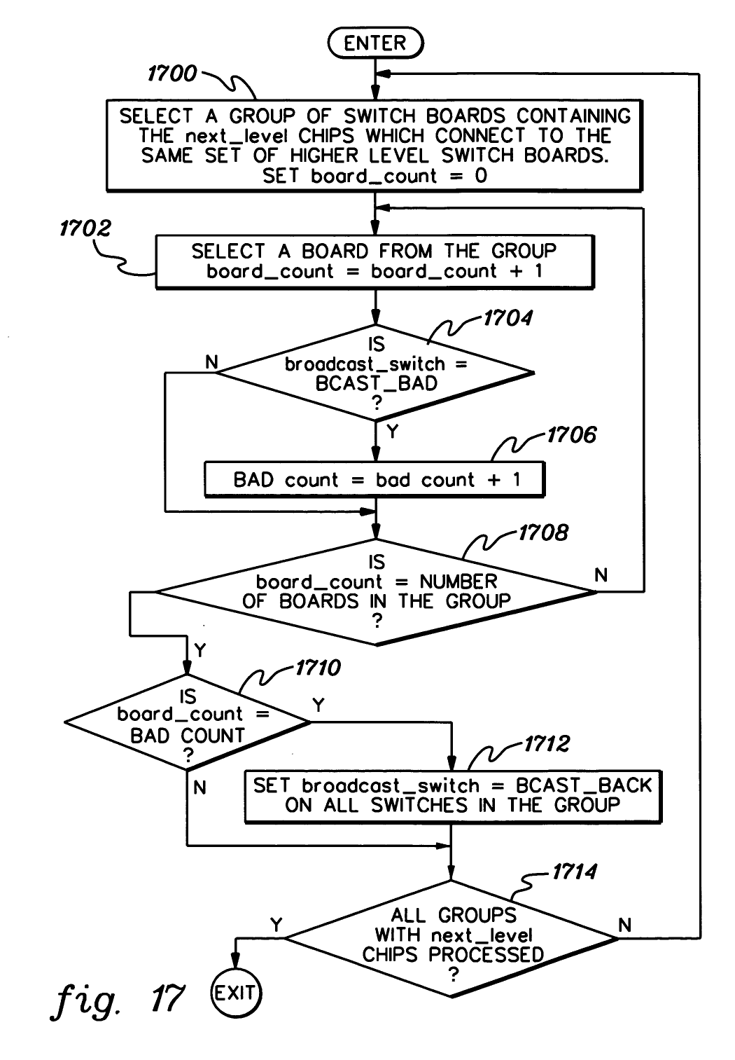

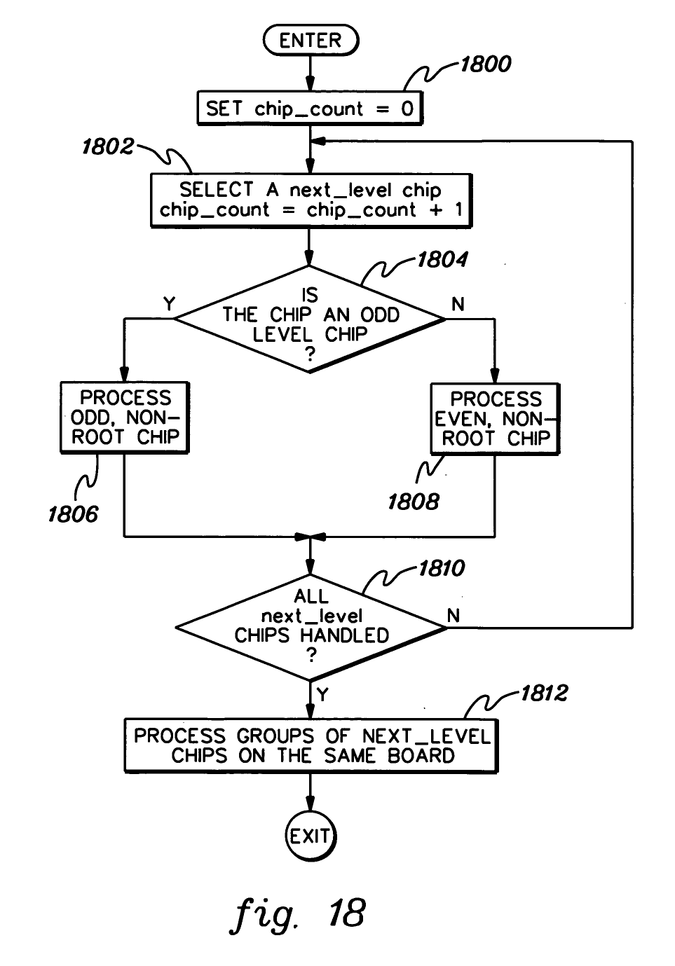

Referring initially to FIG. 16, in one embodiment, to perform the sweep down, next_level is set equal to the root_level-1, STEP 1600, and a determination is made as to whether the level contains an even level chip, INQUIRY 1602. If the level does have an even level chip, then a check is made as to whether the switch boards containing next_level switch chips can send a broadcast packet up to a root chip, STEP 1604. This processing is described further below with reference to FIG. 17. Thereafter, or if the level does not contain an even level chip, the next_level switch chips are processed to determine their ability to reach a root chip that can broadcast globally, STEP 1606. This processing is described with reference to FIG. 18. Next, a determination is made as to whether this is a host level, INQUIRY 1608. If not, then next_level is set to next_level-1, STEP 1610, and processing continues with INQUIRY 1602. Otherwise, the sweep down process is complete, STEP 1612.

Returning to STEP 1604, one embodiment of further details regarding the processing associated with checking the switch boards are described with reference to FIG. 17. Initially, a group of switch boards containing the next_level chips which connect to the same set of higher level switch boards is selected, and the board count is initialized to zero, STEP 1700. Then, a board is selected from the group, and the board count is incremented by one, STEP 1702. A determination is made as to whether the broadcast_switch is equal to BCAST_BAD, INQUIRY 1704. If the status is bad, then the bad count is incremented by one, STEP 1706. Thereafter, or if the broadcast_switch is not equal to BCAST_BAD, a determination is made as to whether the board count is equal to the number of boards in the group, INQUIRY 1708. If not, then processing continues with STEP 1702. Otherwise, processing continues with a determination as to whether the board count is equal to the bad count, INQUIRY 1710. If it is, then broadcast_switch is set equal to BCAST_BACK on all switches in the group, STEP 1712. Thereafter, or if the board count is not equal to the bad count, then a determination is made as to whether all groups with next_level chips have been processed, INQUIRY 1714. If there are more groups to be processed, then processing continues with STEP 1700. Otherwise, processing of boards with next_level chips is complete.

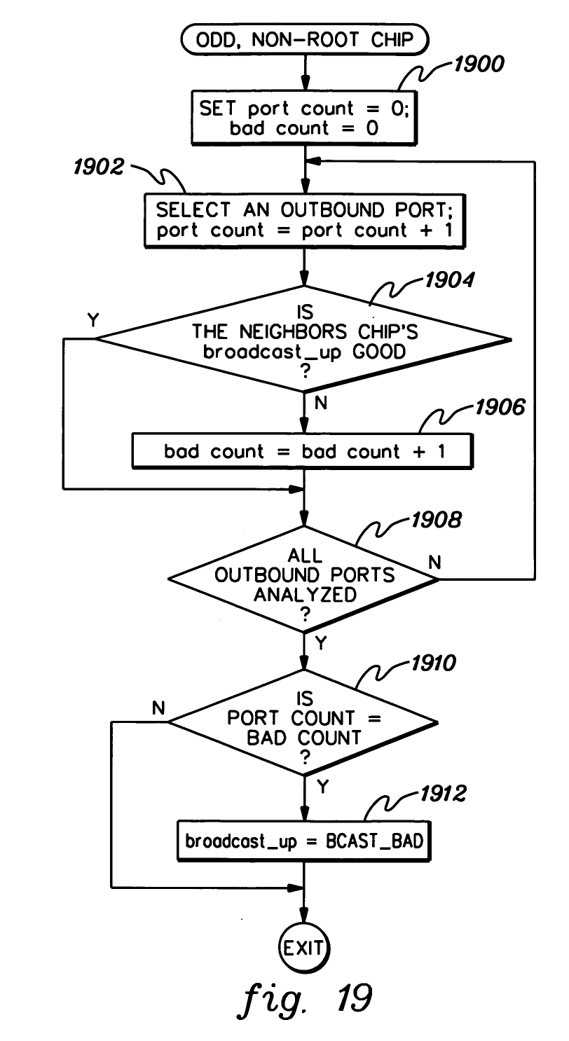

Further details regarding one embodiment of the processing of next_level chips during sweep down (STEP 1606 of FIG. 16) are described with reference to FIG. 18. In one embodiment, the chip count is initialized to zero, STEP 1800, a next_level chip is selected and the chip count is incremented by one, STEP 1802. Then, a determination is made as to whether the chip is an odd level chip, INQUIRY 1804. If it is an odd level chip, then the odd non-root chip is processed, STEP 1806. This processing is described further with reference to FIG. 19.

Referring to FIG. 19, initially, a port count and a bad count are initialized to zero, STEP 1900. Then, an outbound port is selected and the port count is incremented by one, STEP 1902. A determination is made as to whether the neighbor chip's broadcast_up status is set equal to BCAST_GOOD, INQUIRY 1904. If not, then the bad count is incremented by one, STEP 1906. Thereafter, or if the neighbor chip's broadcast_up status is set to good, a determination is made as to whether all outbound ports have been analyzed, INQUIRY 1908. If there are more outbound ports to be analyzed, then processing continues with STEP 1902. Otherwise, processing continues with a determination as to whether the port count is equal to the bad count, INQUIRY 1910. If the port count is equal to the bad count, then broadcast_up is set equal to BCAST_BAD, STEP 1912. Thereafter, or if the port count is not equal to the bad count, then processing an odd non-root chip is complete.

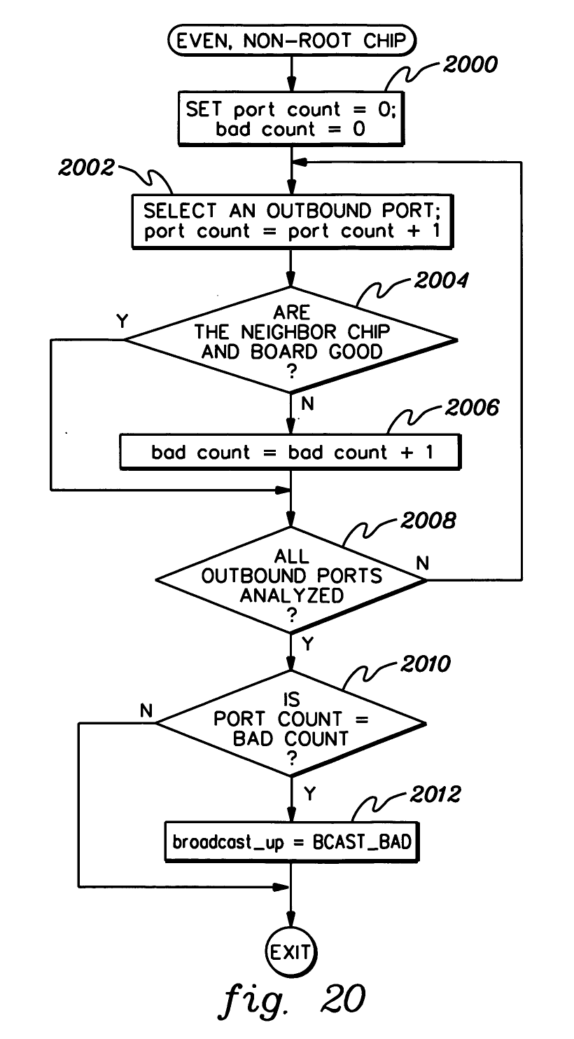

Returning to INQUIRY 1804 (FIG. 18), if the chip is an even level chip, then the logic continues with processing an even non-root chip, STEP 1808. One embodiment of the logic associated with processing an even non-root chip is described with reference to FIG. 20. Initially, the port count and bad count are both set to zero, STEP 2000. Thereafter, an outbound port is selected, and the port count is incremented by one, STEP 2002. A determination is made as to whether the neighbor chip and board are good, INQUIRY 2004. If not, the bad count is incremented by one, STEP 2006. Thereafter, or if the neighbor chip and the board are good, then processing continues with determining whether all outbound ports have been analyzed, INQUIRY 2008. If there are more outbound ports to be analyzed, processing continues with STEP 2002. Otherwise, a determination is made as to whether the port count is equal to the bad count, INQUIRY 2010. If the port count is equal to the bad count, then broadcast_up is set equal to BCAST_BAD, STEP 2012, and processing of an even non-root chip is complete.

Returning to FIG. 18, subsequent to processing the non-root chips, a determination is made as to whether all next_level chips have been processed, INQUIRY 1810. If not, then processing continues with STEP 1802. Otherwise, groups of next_level chips on the same board are processed, STEP 1812, as described below.

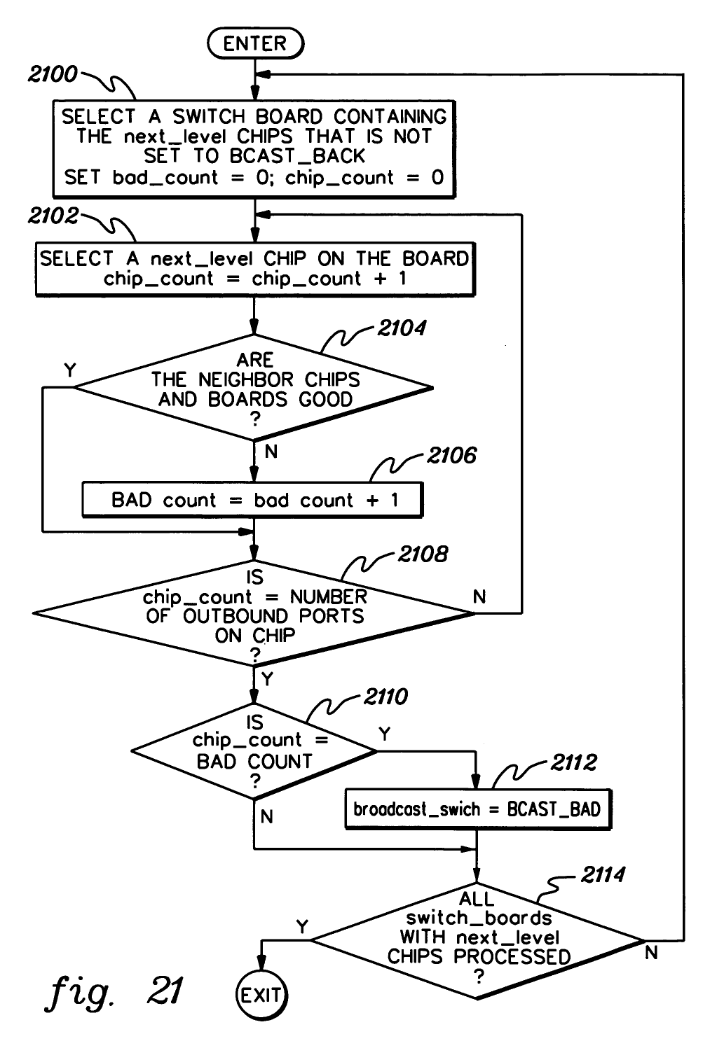

One embodiment of the logic associated with processing groups of next_level chips on the same board is described with reference to FIG. 21. Initially, a switch board containing the next level chips that is not set to BCAST_BACK is selected, and the bad count and chip count are initialized to zero, STEP 2100. Then, a next level chip on the board is selected, and the chip count is incremented by one, STEP 2102. A determination is made as to whether the neighbor chips and boards are good, INQUIRY 2104. If not, then the bad count is incremented by one, STEP 2106. Thereafter, or if the neighbor chips and boards are good, a determination is made as to whether the chip count is equal to the number of outbound ports on the chip, INQUIRY 2108. If not, processing continues with STEP 2102. Otherwise, processing continues with a determination as to whether the chip count is equal to the bad count, INQUIRY 2110. If the chip count is equal to the bad count, then broadcast_switch is set to BCAST_BAD, STEP 2112. Thereafter, or if the chip count is not equal to the bad count, a determination is made as to whether all switch boards with next_level chips have been processed, INQUIRY 2114. If not, processing continues with STEP 2100. Otherwise, processing of chips at the same level on the same board is complete. This also completes the sweep down processing.

With the information obtained during sweep up and sweep down, one or more multicast patterns are set on each switch chip based on the status set by the sweep up and sweep down processes. In one example, a pattern is set for the inbound ports and another is set for the outbound ports. One embodiment of the logic associated with generating multicast or replication patterns is described with reference to FIG. 22. Initially, for all switch chips in the network, ideal multicast lookup table entries (replication patterns) are generated, such that one distinct port is selected for each multicast lookup table entry to send a broadcast packet up to the root level, and a broadcast packet from a root will be replicated and sent out all four ports on the other side of the chip, STEP 2200.

For example, four lookup table entries are set up on each switch chip with indices zero through three. For packets coming in through inbound ports going towards a root chip, a different outbound port is selected and the corresponding bit in the pattern is set to one for each of the four indices. Packets coming in through outbound ports from the root chips are replicated and sent out of all inbound ports to progress towards the hosts. So, the inbound ports on outbound port patterns are set to one. When a pair of root chips are needed to accomplish broadcast, the pattern for inbound ports is set such that all inbound ports carry replicated packets in addition to one outbound port that will reach the other root chip of the pair.

Examples of ideal multicast patterns for a 2048 network are provided below:

Level 5 (Root Level) Chips:

| Patterns for inbound ports | Patterns for outbound ports |
|---|---|
| 111110001 | 111110000 |
| 111110010 | 111110000 |
| 111110100 | 111110000 |
| 111111000 | 111110000 |

Level 2 and Level 4 Chips:

| Patterns for inbound ports | Patterns for outbound ports |
|---|---|
| 110000000 | 100001111 |
| 101000000 | 100001111 |
| 100100000 | 100001111 |
| 100010000 | 100001111 |

Level 2 and Level 4 Chips (BCAST_BACK Pattern)

| Patterns for inbound ports | Patterns for outbound ports |
|---|---|
| 100001111 | 100000000 |
| 100001111 | 100000000 |
| 100001111 | 100000000 |
| 100001111 | 100000000 |

Level 1 (Host Level) and Level 3 Chips:

| Patterns for inbound ports | Patterns for outbound ports |
|---|---|
| 100001000 | 111110000 |
| 100000100 | 111110000 |
| 100000010 | 111110000 |
| 100000001 | 111110000 |

Additionally, for each switch chip in the network, all ideal multicast lookup table values are verified based on the status determined during sweep up and sweep down, STEP 2202. Any bad multicast lookup table value is replaced with a good one. If all ideal values are verified bad, then the values are set to null. Further details with verifying the values and generating the patterns are described with reference to FIGS. 23A-23B.

Referring to FIG. 23A, initially, a switch board is selected, STEP 2300, and a switch chip on the board is selected, STEP 2302. Then, a pattern index is set to one, and a variable, default, is set equal to null, STEP 2304. Next, a multicast lookup table value with index equal to the pattern index is selected, STEP 2306. A determination is made as to whether the outbound link and its upbound neighbor on the pattern are good for broadcast, INQUIRY 2308. For example, the status of the link as detected by the network manager is retrieved from a database and used to determine whether the link is good, and the status from sweep up and/or sweep down are used to determine whether the upbound neighbor is good. If they are good for broadcast, then the selected multicast lookup table value is downloaded to the chip, STEP 2310, and the pattern index is incremented by one, STEP 2316.

Otherwise, a determination is made as to whether the last MLT value was good, INQUIRY 2312. If the last value was good, then the last good multicast lookup table value is downloaded to the chip, STEP 2314. Thereafter, or if the last value was not good, the pattern index is set equal to the pattern index+1, STEP 2316. After setting the pattern index, a determination is made as to whether the pattern index is valid, (e.g., within bounds of the available number of patterns), INQUIRY 2318. If it is valid, then processing continues with STEP 2306. Otherwise, processing continues with STEP 2320.

Referring to FIG. 23B, a determination is made as to whether all patterns were bad, INQUIRY 2330. If all patterns were bad, then the default value for all indexed locations are downloaded to the chip, STEP 2332. However, if all patterns were not bad, then a determination is made as to whether the first pattern was downloaded, INQUIRY 2334. If the first pattern was not downloaded, then the last good multicast lookup table value is downloaded to the first pattern index, STEP 2336. Thereafter, or if the first pattern was downloaded, or if the default values were downloaded, a determination is made as to whether there are any more chips on the board, INQUIRY 2338. If so, then processing continues with STEP 2302 (FIG. 23A), STEP 2340 (FIG. 23B). Otherwise, if there are no more chips on the board, a determination is made as to whether there are any more boards to be processed, INQUIRY 2342. If so, then processing continues with STEP 2300 (FIG. 23A), STEP 2344 (FIG. 23B). However, if there are no more chips on the board and no more boards to be processed, then processing to select and download multicast lookup table values to switches is complete, STEP 2346.

Described in detail above is a capability to determine multicast patterns to facilitate efficient, reliable broadcast in a multistage network. To summarize, the process includes:

1. Sweep up: Process the switch chips starting from those closest to the hosts to those at the center stage of the network to determine their ability to send packets to root chips at the center stage of the network, as well as broadcast down to hosts underneath.
Process all level 1 chips to determine if they are good for broadcasting up to level 2. If all four links going up are BAD, mark the chip state as bad for broadcast (BCAST_BACK).
Process level 2 chips if they are good for broadcasting up to level 3, if it exists. A chip will be deemed bad for broadcast up if all four up links from it are bad. When a chip is deemed bad for broadcast up, it's broadcast up status is marked BCAST_BAD. If all four level 2 chips on a board are bad, the board state is marked BCAST_BACK. The broadcast down status of each chip is determined based on whether it can reach all good level 1 chips (i.e., those that have not been declared as BCAST_BACK) connected to it. If the broadcast down status is bad, it is so marked.
Process level 3 chips based on whether they are root level chips or not.
If level 3 chips are root chips, determine whether they can reach all level 2 chips. If they cannot, deem them as BAD for broadcast. If a connected pair of level 3 chips are needed for broadcast to all, determine if such a pair is available on a switch board. Deem all boards that do not have the necessary root chip or root-chip pair to be BCAST_BAD.
If level 3 chips are not root chips, determine if each of them can broadcast up to level 4 and mark them accordingly as BCAST_GOOD or BCAST_BAD.
Process level 4 chips based on whether they are root level chips or not.
If level 4 chips are root level chips, check if it can reach all level three chips connected to it and whether all of the level 3 chips connected to it can reach all BCAST_GOOD level 2 chips connected to it. If any of the two conditions fail, deem the chip to be bad for broadcast down. If all four level 4 chips on a board are deemed bad, mark the board down as BCAST_BAD.
If level 4 chips are not root chips, determine if each of them can broadcast up to level 4 and mark them accordingly as BCAST_GOOD or BCAST_BAD.
Process all higher odd levels like level 3 chips and process all higher even levels like level 4 chips until the root chips for the particular network configuration or topology are processed.

2. Sweep down: Process back from the center stage switch chips down to the host chips modifying their broadcast status based on status of higher level chips.

3. Set the multicast pattern on each switch chip based on the status set by the sweep up and sweep down steps such that:
every network host is able to broadcast to every other network;
the receivers do not receive any duplicate packets from any sender; and
no broadcast hotspots are created in the network.
Starting from the chips at the highest level, determine if the switch is to be set up for broadcast. If so, for each port that can broadcast down, check if the link is good and the neighbor's broadcast status is good. If so, build the MLT pattern for the port and assign it to one of the available look-up indices. In one example, there are four indices. If it is bad, replace it with any good pattern available for the chip. If no pattern is available, the chip is not capable of broadcast and will have a NULL pattern stored to it.
Once all patterns are computed, write them to the respective look-up tables on the switch chips.

In one embodiment, the logic is run and values updated whenever new faults are seen in the cluster or when faults are repaired. One advantage of this scheme is that it is fast and does not require any action to be taken on the hosts when changes occur in the status of the links in the network.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of one or more aspects of the present invention. The article of manufacture can be included as a part of a computer system or sold separately.

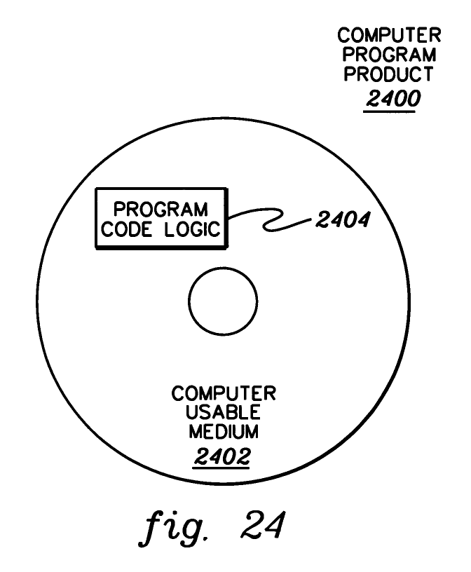

One example of an article of manufacture or a computer program product incorporating one or more aspects of the present invention is described with reference to FIG. 24. A computer program product 2400 includes, for instance, one or more computer usable media 2402 to store computer readable program code means or logic 2404 thereon to provide and facilitate one or more aspects of the present invention. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

Advantageously, efficient reliable broadcast support is provided to clients of a network built using switch elements that have the capability to replicate packets. The management of the replication packets on a network is transparent to the hosts. Appropriate replication patterns are determined for a network with arbitrary faults, and correct patterns are maintained dynamically without the hosts requiring any knowledge of the current state of the network. Further, advantageously, every network host is able to broadcast to every other network host every time a broadcast is attempted; the management of replication packets on a network is transparent to the host; the receivers do not receive any duplicate packets from any sender; and no broadcast hotspots are created in the network.

By exploiting the hardware, a broadcast function is provided that is at hardware speed as compared to software implementations of broadcast.

Although examples are described herein, many variations to these examples may be provided without departing from the spirit of the present invention. For instance, switch networks, other than the High Performance Switch network offered by International Business Machines Corporation, may benefit from one or more aspects of the present invention. Similarly, other types of networks may benefit from one or more aspects of the present invention. Further, the switch network described herein may include more, less or different devices than described herein. For instance, it may include less, more or different nodes than described herein, as well as less, more or different switch frames than that described herein. Additionally, the links, adapters, switches and/or other devices or components described herein may be different than that described and there may be more or less of them. Further, the service network may include less, additional or different components than that described herein.

In yet other embodiments, components other than network managers may perform one or more aspects of the present invention. Further, a network manager may be part of the communications network, separate therefrom or a combination thereof. Yet further, the number of multicast lookup table entries provided and/or written on the switch chip may be different than that described herein.

Additionally, the network can be in a different environment than that described herein. Many other variations exist.

For instance, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, etc.) can be coupled to the system either directly or through intervening I/O controllers. Network adapters may also be coupled to the system to enable the data processing system to become coupled to other data processing systems or remote printers storage devices through intervening private or public networks. Modems, cable modems and Ethernet cards are just a few of the available types of network adapters.

The capabilities of one or more aspects of the present invention can be implemented in software, firmware, hardware or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating broadcasting in a communications network, said method comprising:
generating one or more replication patterns to be used in broadcasting data in the communications network; and
providing at least one replication pattern of the one or more replication patterns in hardware of the communications network to enable broadcasting from one node of the communications network to each node of a broadcast domain of the communications network.

2. The method of claim 1, further comprising determining an ability of a plurality of switching elements of the communications network to send data, and wherein the generating of the one or more replication patterns is based on the determining.

3. The method of claim 2, wherein the determining comprises:
processing the plurality of switching elements starting with one or more switching elements closest to one or more hosts of the communications network to one or more switching elements at a center stage of the communications network to determine an ability of the plurality of switching elements to send data to one or more root chips at the center stage of the communications network and to broadcast down to one or more hosts; and
processing back from the center stage one or more switching elements down to one or more switching elements at the one or more hosts to further determine the ability of the plurality of switching elements to send data.

4. The method of claim 3, wherein the processing of the plurality of switching elements comprises:
processing one or more level one switching elements to determine their ability to broadcast up; and
processing one or more switching elements of at least one higher level to determine their ability to broadcast up and to broadcast down.

5. The method of claim 4, wherein the processing of a level one switching element comprises:
determining status of one or more links of one or more outbound ports of the level one switching element; and
setting a broadcast status of the level one switching element based on the status.

6. The method of claim 4, wherein the processing of a switching element of a higher level comprises:
determining whether the switching element is an odd non-root element, an odd root element, an even root element or an even non-root element; and
processing the switching element based on the determining.

7. The method of claim 3, wherein the processing back comprises:
selecting a level to be processed;
determining whether the selected level includes an even level switching element;
checking, in response to the determining indicating an even level switching element, whether one or more switch boards including switching elements of the selected level can broadcast up to a root switching element; and
processing one or more switching elements of the selected level to determine their ability to reach a root switching element that can globally broadcast.

8. The method of claim 7, further comprising repeating the selecting, determining, checking and processing zero or more times until the host level is processed.

9. The method of claim 1, wherein the generating of a replication pattern of the one or more replication patterns comprises:
generating the replication pattern for a switching element of the communications network, wherein one or more values of the replication pattern is set such that one distinct port is selected to send a broadcast up to a root level and a broadcast from the root level is replicated and sent out multiple ports on the other side of the switching element; and
verifying the one or more values of the replication pattern based on status of the switching element.

10. The method of claim 1, wherein the one or more replication patterns represent one or more replication paths of the communications network, and wherein management of the one or more replication paths is transparent to hosts of the communications network.

11. The method of claim 1, wherein the generating of the replication patterns ensures at least one of the following:
a replication pattern of the one or more replication patterns is generated such that a receiver of data does not receive duplicate data from a sender of data; and
no broadcast hotspots are created in the communications network.

12. A method of facilitating broadcasting in a multistage network, said method comprising:
processing a plurality of switch chips of the multistage network starting with one or more switch chips closest to one or more hosts of the multistage network to one or more switch chips at a center stage of the multistage network to determine an ability of the plurality of switch chips to send data to one or more root chips at the center stage of the multistage network and to broadcast down to one or more hosts;
processing back from the center stage one or more switch chips down to one or more switch chips at each host of a broadcast domain to further determine the ability of the plurality of switch chips to send data; and
generating one or more replication patterns for one or more switch chips based on the processing of the plurality of switch chips and the processing back.

13. A system for facilitating broadcasting in a communications network, said system comprising:
one or more replication patterns to be used in broadcasting data in the communications network; and
hardware of the communications network in which at least one replication pattern of the one or more replication patterns is placed to enable broadcasting from one node of the communications network to each node of a broadcast domain of the communications network.

14. The system of claim 13, further comprising a component adapted to determine an ability of a plurality of switching elements of the communications network to send data, and to generate the one or more replication patterns based on the determining.

15. The system of claim 14, wherein the component adapted to determine is further adapted to:
process the plurality of switching elements starting with one or more switching elements closest to one or more hosts of the communications network to one or more switching elements at a center stage of the communications network to determine an ability of the plurality of switching elements to send data to one or more root chips at the center stage of the communications network and to broadcast down to one or more hosts; and
process back from the center stage one or more switching elements down to one or more switching elements at the one or more hosts to further determine the ability of the plurality of switching elements to send data.

16. The system of claim 13, wherein for a replication pattern of the one or more replication patterns the component is further adapted to:
generate the replication pattern for a switching element of the communications network, wherein one or more values of the replication pattern is set such that one distinct port is selected to send a broadcast up to a root level and a broadcast from the root level is replicated and sent out multiple ports on the other side of the switching element; and
verify the one or more values of the replication pattern based on status of the switching element.

17. An article of manufacture comprising:
at least one computer usable medium having computer readable program code logic to facilitate broadcasting in a communications network, the computer readable program code logic comprising:
generate logic to generate one or more replication patterns to be used in broadcasting data in the communications network; and
provide logic to provide at least one replication pattern of the one or more replication patterns in hardware of the communications network to enable broadcasting from one node of the communications network to each node of a broadcast domain the communications network.

18. The article of manufacture of claim 17, further comprising logic to determine an ability of a plurality of switching elements of the communications network to send data, and wherein generation of the one or more replication patterns is based on the determining.

19. The article of manufacture of claim 18, wherein the logic to determine comprises:
process logic to process the plurality of switching elements starting with one or more switching elements closest to one or more hosts of the communications network to one or more switching elements at a center stage of the communications network to determine an ability of the plurality of switching elements to send data to one or more root chips at the center stage of the communications network and to broadcast down to one or more hosts; and
process back logic to process back from the center stage one or more switching elements down to one or more switching elements at the one or more hosts to further determine the ability of the plurality of switching elements to send data.

20. The article of manufacture of claim 17, wherein the generate logic for a replication pattern of the one or more replication patterns comprises:
logic to generate the replication pattern for a switching element of the communications network, wherein one or more values of the replication pattern is set such that one distinct port is selected to send a broadcast up to a root level and a broadcast from the root level is replicated and sent out multiple ports on the other side of the switching element; and
verify logic to verify the one or more values of the replication pattern based on status of the switching element.
